(19) United States
(12) Patent Application Publication
(10) Pub. No.: US 2010/0057610 A1
(43) Pub. Date: Mar. 4, 2010

(54) Mortgage refinance notification and marketing system

(76) Inventor: Jeffrey A. Pinkerton, Suwanee, GA (US)

Correspondence Address: Frilot, LLC, 1100 Poydras St., Suite 3700, New Orleans, LA, 70163, US

(21) Appl. No.: 12/460,217

(22) Filed: Jul. 14, 2009

Related U.S. Application Data
(60) Provisional application No. 61/135,112, filed on Jul. 17, 2008.

(51) Int. Cl. G06Q 40/00; G06F 15/16

(52) U.S. Cl. 705/38; 709/204

(57) ABSTRACT

A computerized mortgage loan notification and marketing system and process to enable mortgage professionals or others to provide automated notification and reports to individuals setting forth the availability of mortgage loans. The individual's desired loan parameters are obtained and calculations are made to determine whether the desired loan is available. If the desired loan becomes available, a notification is automatically presented to the individual. A system for providing mortgage professionals with automated notifications that their customers' desired loan terms are available is also disclosed.

### CROSS REFERENCE TO RELATED PROVISIONAL APPLICATION

This application claims the benefit of U.S. Provisional Patent Application No. 61/135,112 filed on Jul. 17, 2008, the disclosure of which is incorporated by reference in its entirety.

### BACKGROUND OF INVENTION

The present invention relates generally to a computerized mortgage refinance notification and marketing system that permits mortgage professionals, their clients, and others to manage and track mortgage loan finance and refinance options, while also providing mortgage professionals with a web-based platform to market to existing and future clients using system-generated, customized notifications indicating that a client's desired refinance terms are available and refinance reports detailing the available refinance options.

Generally, individuals approach mortgage professionals, like mortgage sales people, brokers, and lenders, for information regarding whether it would be beneficial to finance or purchase or refinance an existing mortgage loan.

Other than advertisements promising teaser interest rates or websites offering generic mortgage calculators, most mortgage professionals do not utilize any products to market to past, current, or potential clients the availability of customer-specific refinance options. Instead, they simply wait for a client to contact them, input the client's mortgage information into their loan software, provide an estimate of available loans, and calculate by hand whether the available loans would benefit the client. This results in the mortgage professional having to input the client's existing mortgage information, along with interest rate, closing cost, and other information, each time finance or refinance options are requested. Interest rates alone generally change on a daily, and sometime hourly, basis. The process of inputting client data, updating that day's interest rate information, assessing the applicable closing costs based on the state where the property is located, printing an estimate of charges, labeling an envelope, and mailing (or emailing) the report to the client is cumbersome and tedious, resulting in lost time and missed opportunities for the mortgage professional.

### SUMMARY OF INVENTION

The web-based, computerized mortgage refinance notification and marketing system and process in accordance with the present invention solves the aforementioned problems by providing mortgage professionals, clients, and individuals with an easy and efficient manner in which to track, communicate, and market refinance options. Overall, the method and system according to the present invention provides mortgage professionals and others with the ability to store marketing and client information, calculate refinance or finance options based upon the client's current loan and current market conditions and provide refinance reports detailing available loan options that are client and loan-specific and based on current market factors (i.e. interest rates and applicable closing costs). These reports are automatically sent by the system to the client on a regular basis letting them decide if there are any viable refinance options available and can also be requested instantly by a client (and viewed by their mortgage professional as well). The system also stores a client's desired refinance loan terms, and when those terms become available in the market or from their mortgage professional, the system will automatically generate and send notifications setting forth that those desired loan terms are available. The present invention can also be adapted to fit changing needs and goals.

The preferred method according to the present invention involves obtaining and storing mortgage professional's marketing and other information; obtaining and storing mortgage professional's client's (or individual's) existing mortgage loan information; obtaining and storing a client's (or individual's) desired mortgage loan terms (for example, a lower interest rate); obtaining and storing mortgage market data like base mortgage rates and other market factors; processing the aforementioned information to determine if the desired mortgage loan terms are available; processing the aforementioned information to determine the available loan terms; generating an automated notification indicating that the desired loan terms are available; and providing refinance reports with refinance options and marketing information. The preferred system according to the present invention provides means for effecting the foregoing preferred process steps.

Other aspects and advantages of the invention will in part be obvious and will in part be apparent from the specification.

Accordingly, the present invention comprises the various steps and the relation of one or more of such steps with respect to each of the others, and the system embodies features of construction, combinations of elements, and arrangements of parts which are adapted to effect such steps, all as exemplified in the following detailed disclosure. The scope of the invention will be indicated in the claims.

### BRIEF DESCRIPTION OF DRAWINGS

For a better understanding of the invented process, reference is made to the following description taken in connection with the accompanying drawings in which:

FIG. 1 is a schematic diagram of a system constructed and arranged in accordance with a preferred embodiment of the present invention;

FIG. 2 is a high-level flow chart depicting a process flow and preferred embodiment of a system and process that markets, manages, and tracks mortgage loan finance and refinance options according to the present invention;

FIG. 3 is a flow chart depicting a preferred embodiment of the process of providing mortgage loan notifications and marketing information according to the present invention;

FIG. 4 is a flowchart of system inputs and outputs that provides further support of the process of providing mortgage loan notifications and marketing information according to the present invention;

FIGS. A through T depict exemplary user interface displays, notifications and refinance reports illustrating aspects of the mortgage refinance notifications and marketing system according to the present invention.

### DETAILED DESCRIPTION OF THE PREFERRED EMBODIMENTS

Currently, there are products that allow a mortgage professional, like mortgage sales people, brokers, and lenders, to market their services by providing clients, potential clients, or individuals with reports detailing available mortgage loan refinance options. These products, however, require the mortgage professional to input a variety of information on a case-by-case basis, like client-specific existing mortgage data, current interest rates and applicable closing costs, each time they want to provide a refinance report. The process of inputting client data, updating mortgage rates, inputting closing costs based on the state where the property is located, and then mailing or emailing the report to the client is tedious and cumbersome. Furthermore, such refinance reports are available to a client only when the mortgage professional takes the time to generate a report. Thus, for the experienced mortgage professional, the idea of delivering hundreds or even thousands of refinance reports is simply unrealistic.

The method and system according to the present invention avoids the disadvantages and constraints set forth above by enabling mortgage professionals and others to upload and save existing and desired loan client data and marketing information into the web-based system, automate the sending of notifications to the mortgage professional and client indicating that based on real-time market factors the desired mortgage loan terms are available, and automate the sending of refinance reports setting forth the terms, costs, and benefits of the available mortgage products. As a result, with minimal time invested, the system provides the mortgage professional with the ability to market their services to their clients and others through the automatic generation of notifications and refinance reports indicating available mortgage products. The inventive system and process can be provided in real time over a global computer network, such as, for example, the Internet.

More specifically, the system provides mortgage professionals with a web-based platform to market to individuals, like existing and future clients, using system-generated, customer-specific and loan-specific refinance notifications and reports. The client (or individual), web-based interface can be branded entirely with their mortgage professional's marketing information (like photos, company logos, contact information, etc.) and all notifications and finance or refinance reports can be sent by the system to clients by email or otherwise “courtesy of” the mortgage professional. The system also provides the mortgage professional with the ability to customize parts of the refinance notifications and reports to provide additional marketing information.

The system provides mortgage professionals with the ability to enter clients and their loan information in to the system in varying ways. Client information can be uploaded to the system from an existing database or inputted individually. Mortgage professionals can also advertise promotional codes to potential clients that allow the clients to login to the web-based system, input their loan information, and receive free refinance notifications and reports “courtesy of” the mortgage professional.

The system is an automated process. Once a mortgage professional's marketing information, costs and other factors are entered into the system, the mortgage professional can establish a database of client information, existing loan information (like existing loan balance, interest rate, term, payment, etc.) and desired loan terms (like desired loan program, balances, monthly payment, payment schedule, interest rate, and other factors). That information is then stored by the web-based system. Mortgage market data like base mortgage rate information and other market factors are then inputted or retrieved by the system daily or throughout the day as market changes cause mortgage interest rates to fluctuate. The system processes the inputted information and calculates whether the client's desired loan terms are available. If a desired loan term is available, the system automatically generates a customized notification that is delivered to the client and mortgage professional by email or otherwise indicating that based upon the information entered into the system, current market conditions like available interest rates, and mortgage professional variables, the client's desired loan terms are available. When a refinance notification is sent, the client then has the option to request a more detailed refinance report, setting forth the available loan options. Regardless of whether a client's desired loan terms are available, the system can also be customized to generate and deliver incremental refinance reports; or one may log-on to the web-based interface and request a refinance report at any time.

Once the aforementioned information is in the system, refinance notifications and reports are automatically generated for and delivered to the clients by the system without the mortgage professional or individual having to take additional steps. Furthermore, refinance notifications and reports can be branded with the mortgage professional's name, company logo, cover letter, and other marketing information, and sent “courtesy of” the mortgage professional, directing the client to contact the mortgage professional for assistance in refinancing their loan or for additional information.

While discussed herein in the context of financing or refinancing mortgage loans, it should be understood that the present invention is not limited to such loans, but has application with respect to other types of loans.

The inventive system and process can be implemented using a related combination of automated interfaces and manual processes. However, it should be understood that greater use of automated processing and a wider range of product features with multiple executions and elections are also contemplated by the subject invention.

### Computer System

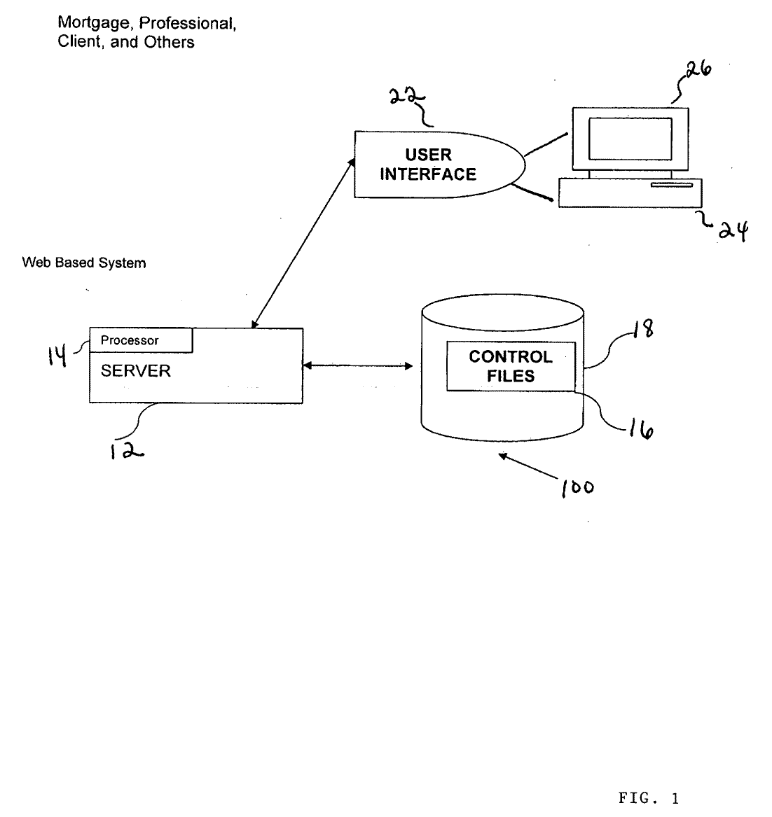

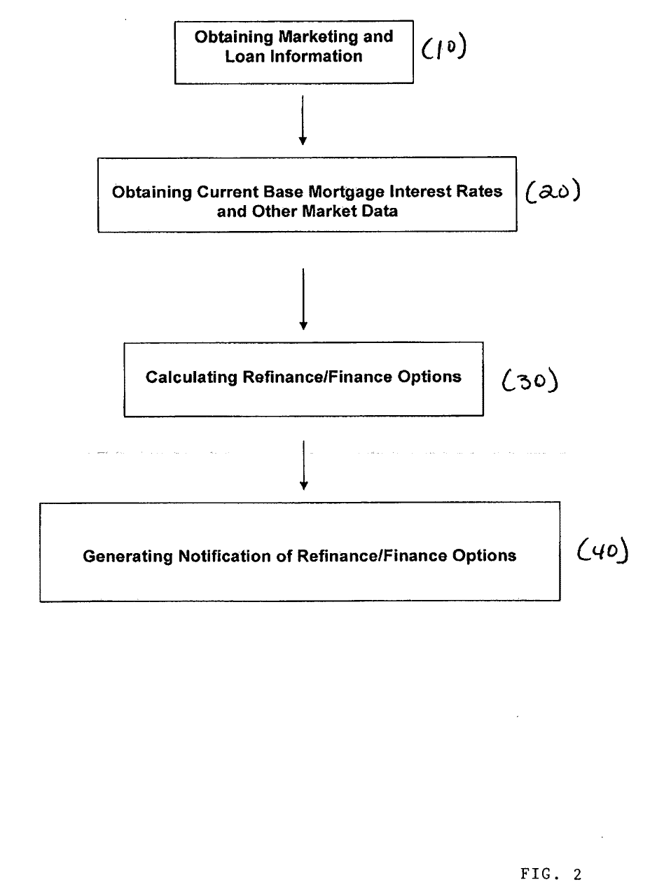

FIG. 1 depicts a simplified schematic illustration of a computer system, generally referred to as “system 100”, which exemplifies the component elements and means necessary to effect and control the various process steps according to the present invention as described hereinafter. Desirably, and where appropriate, system 100 utilizes existing computer capabilities, both hardware and software, and electronic communication links, for example, to receive, store, process, calculate and display mortgage professional and client data, mortgage terms, marketing information, mortgage market data, and other information.

Referring to FIG. 1, System 100 preferably is a web-based (internet) system which preferably includes a computer server 12 which includes a processor 14. Server 12 preferably has electronic access to a database 16 in which files 18 can be stored with information like client and mortgage professional data, existing mortgage information, desired mortgage loan terms, mortgage market data, and other information. Server 12 operates under the control of computer software to carry out the inventive process steps described in greater detail hereinafter. The computer software can include sets of software objects and program elements collectively having the ability to execute independently in a separate thread or logical chain of process execution, while performing the flow of data inputs therebetween. Each can be executed as a separate logical server or using a separate physical device. However, for individuals and mortgage professionals, server 12 preferably operates as a single logical server.

User interface 22 is preferably a remote interface coupled to remote server 12 via a publicly accessible global computer network. A common example of such a network is the Internet.

It should be understood that the inventive system's functions overlap with respect to the flow of data inputs therethrough in order to avoid requiring entry of the same data more than once. As an example, if a mortgage professional inputs a client's existing mortgage information into the system and system 100 uses that information and other information like mortgage market data to calculate the available loan terms, that same information can be used in generating the refinance report and notifications, all as described in greater detail below.

### Users

Users of the inventive system may include but are not limited to mortgage professionals, like mortgage sales people, brokers, and lenders, their clients, as well as individuals seeking to finance or refinance loans.

### Flowcharts

Referring now to FIG. 2, the high-level process flow for a mortgage loan notification and marketing system according to the present invention preferably involves a mortgage professional or individual establishing a customized account and uploading or inputting existing mortgage information and desired loan terms, and marketing information, into the web-based system 100 (step 10); a site administrator entering mortgage market data into system 100 or the system automatically retrieving mortgage market data through the internet or otherwise (step 20); system 100 processing (step 30) the inputted information (step 10) and mortgage market data information (step 20) to determine if the target or desired loan terms are available and/or determine multiple mortgage refinance options (step 30); and system 100 generating an automated notification by e-mail to the mortgage professional, client, and/or individual indicating that a target or desired loan term is available and/or providing multiple refinance options in the form of a refinance report (step 40).

### Obtaining and Storing Mortgage Professional Information

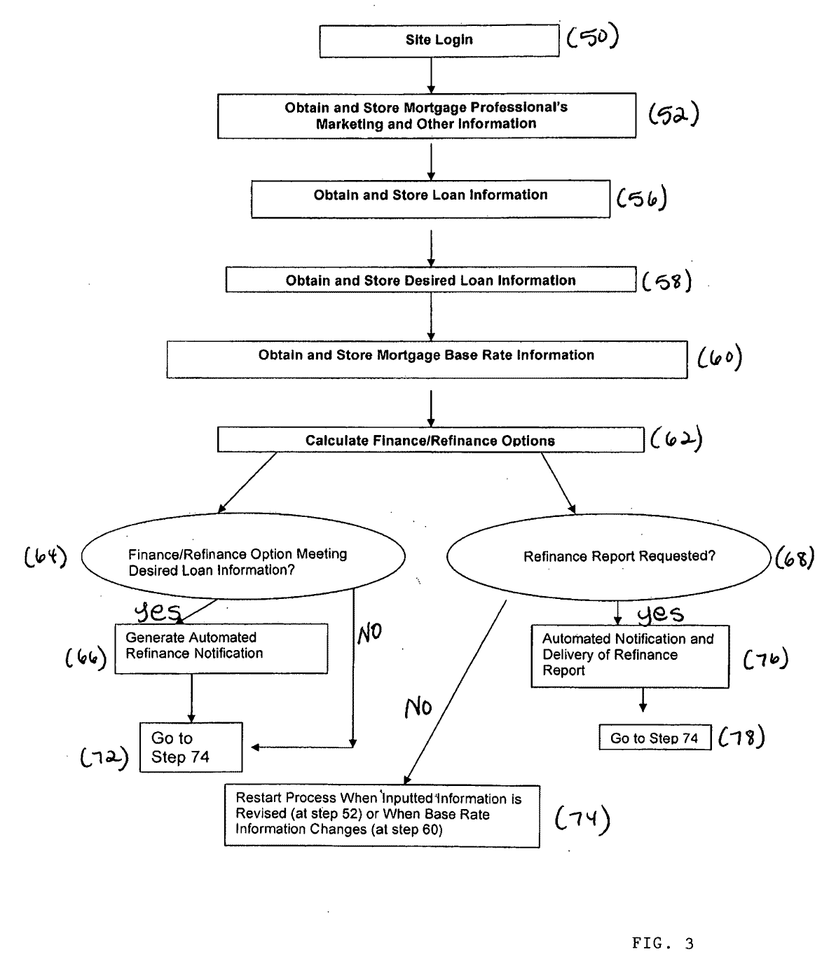

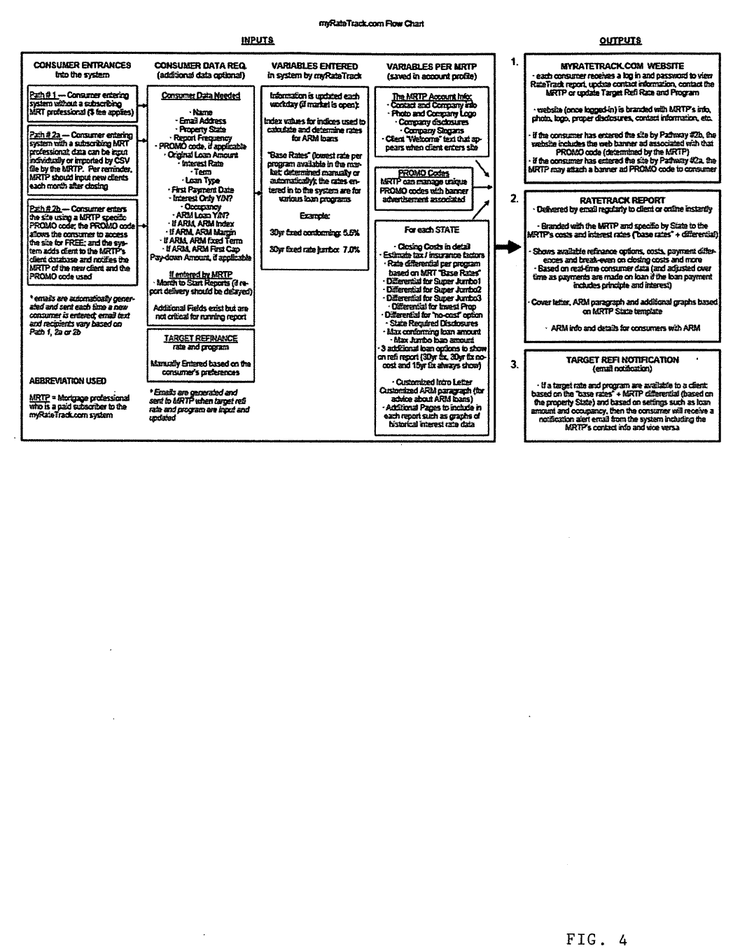

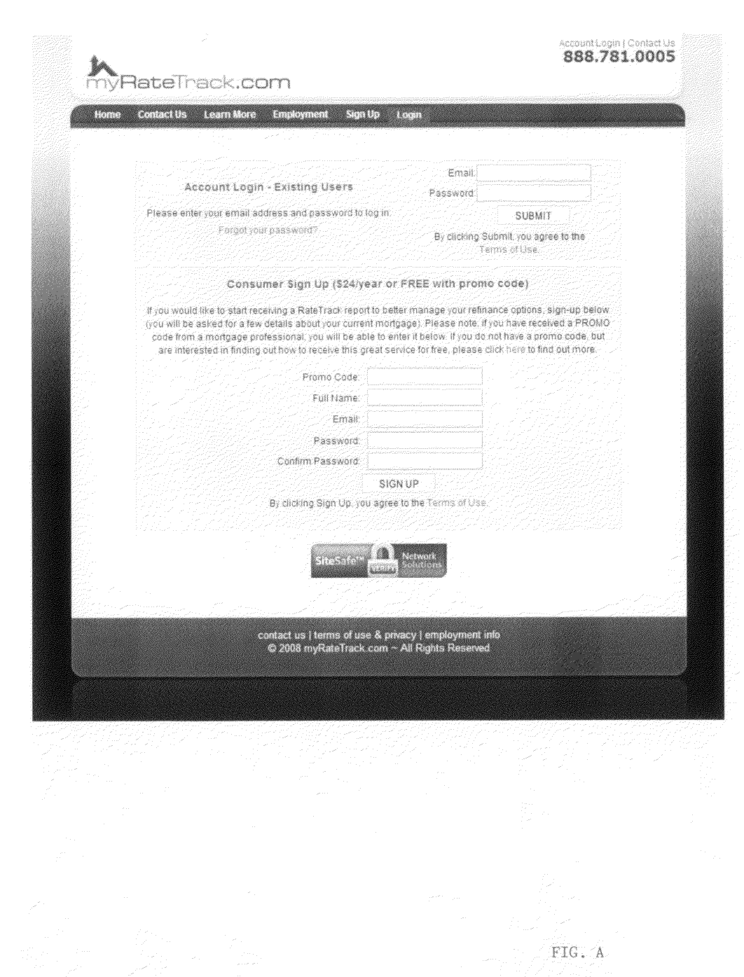

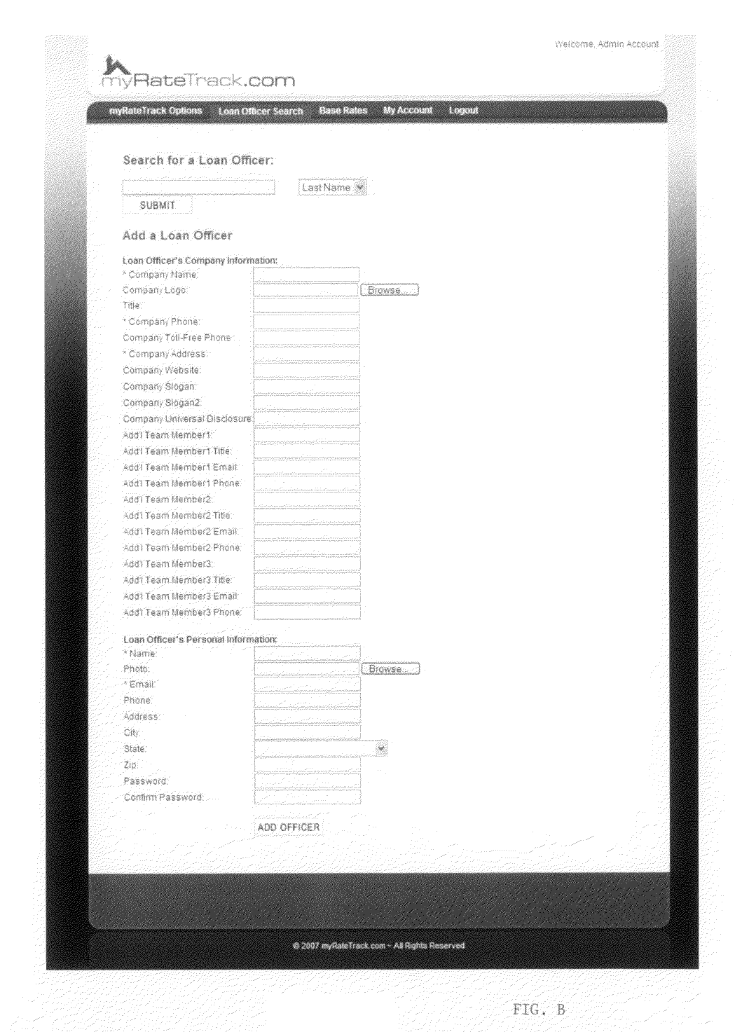

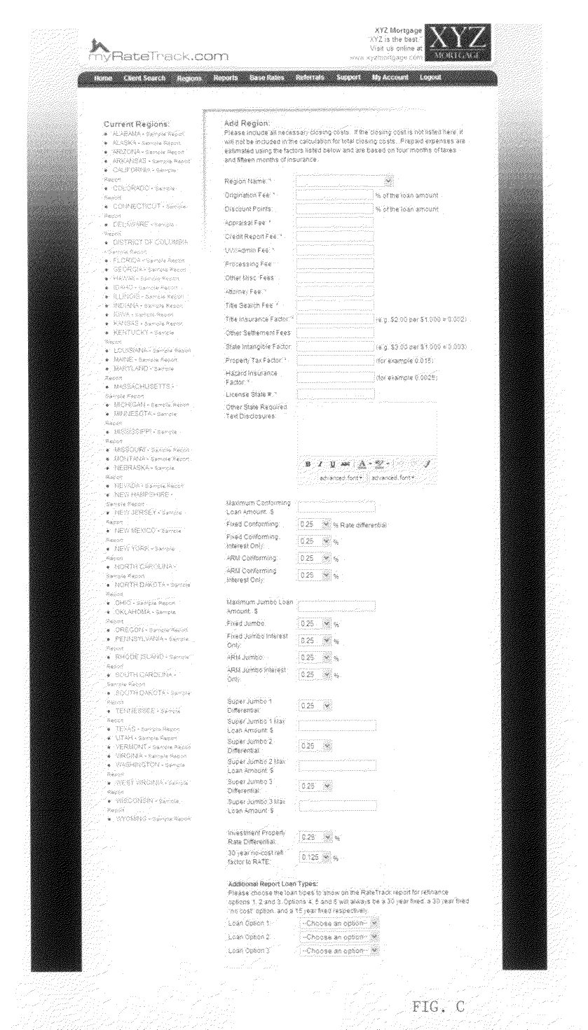

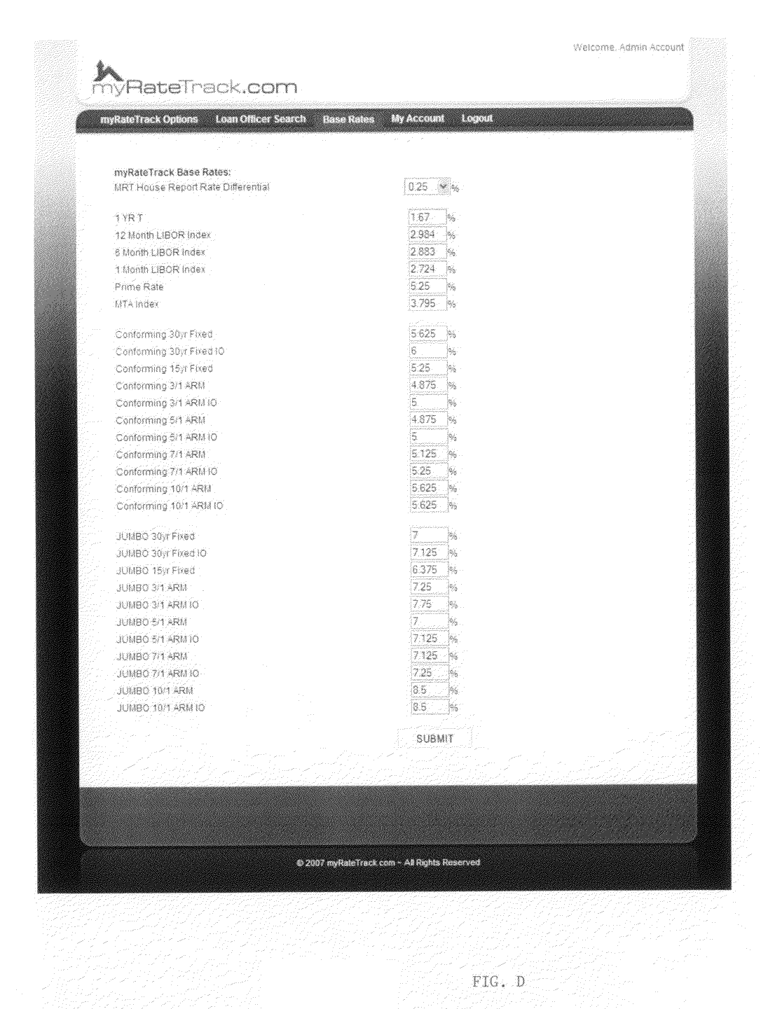

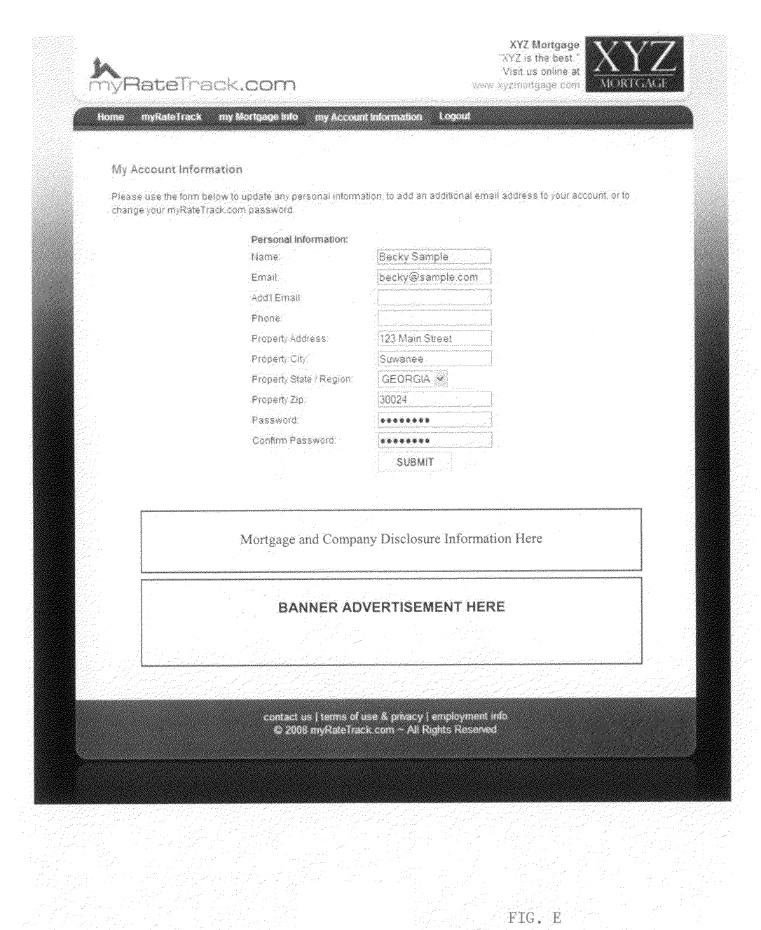

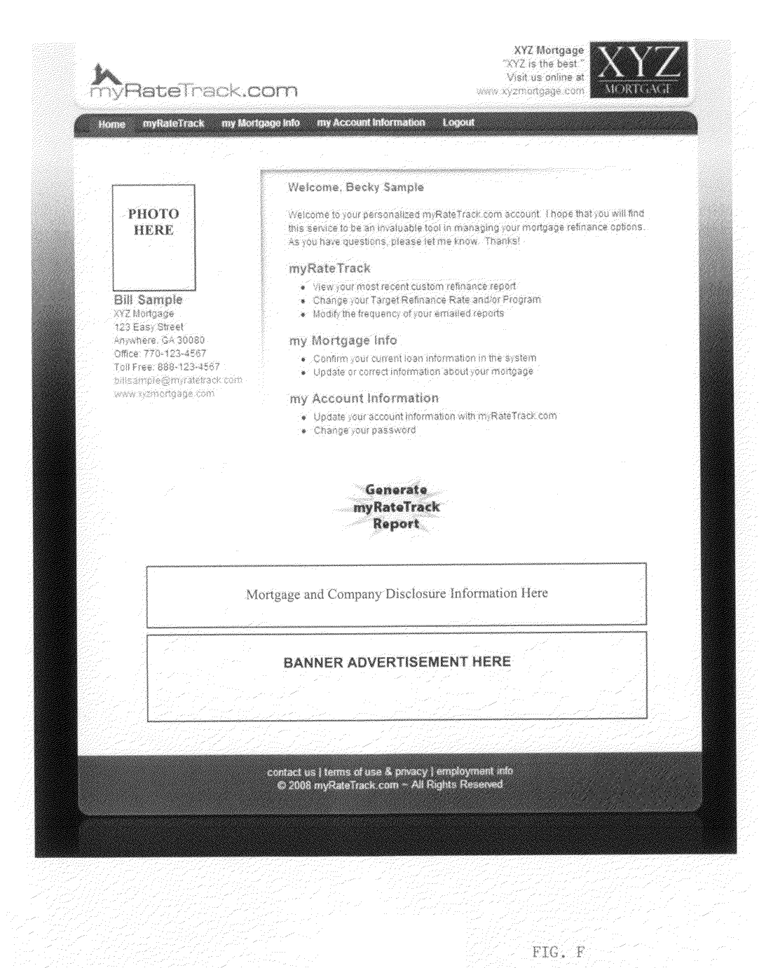

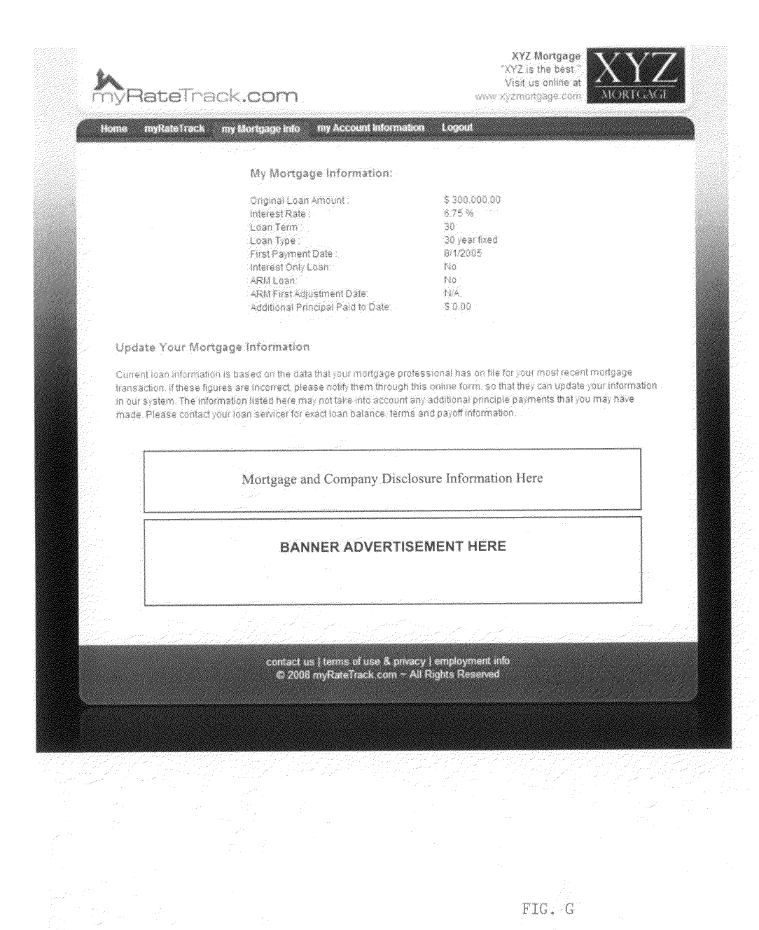

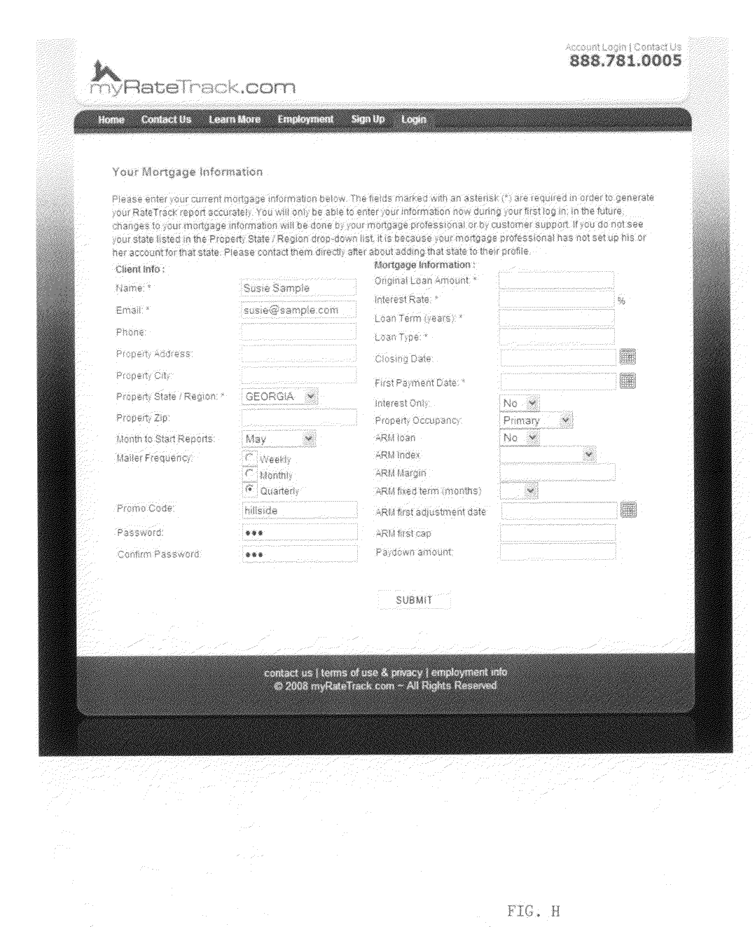

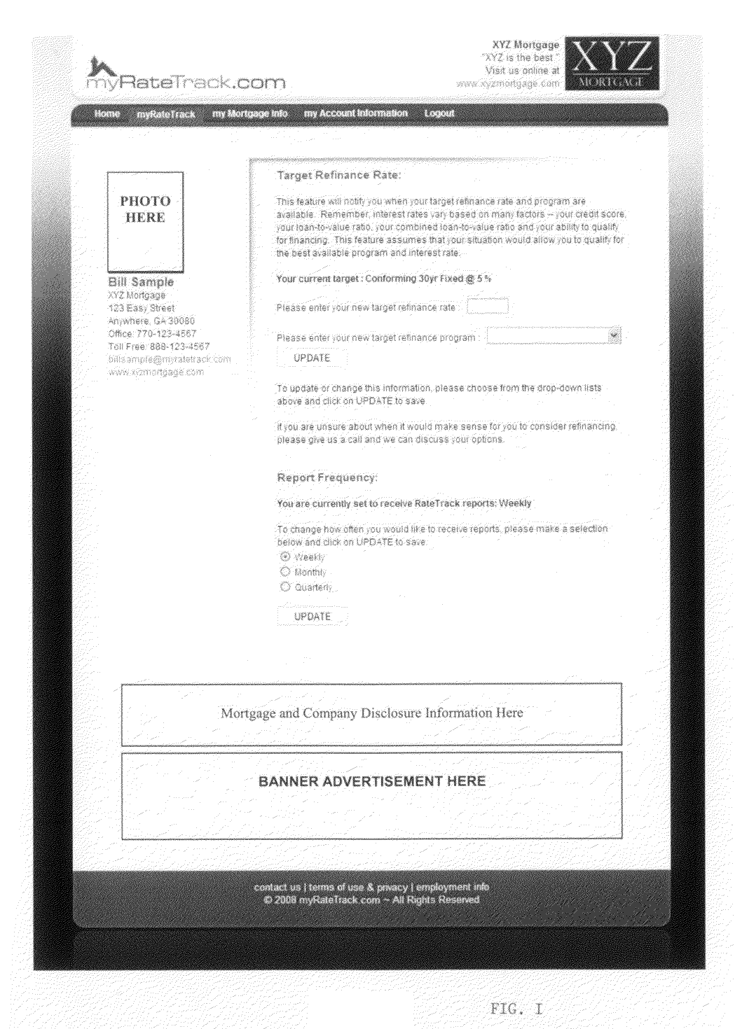

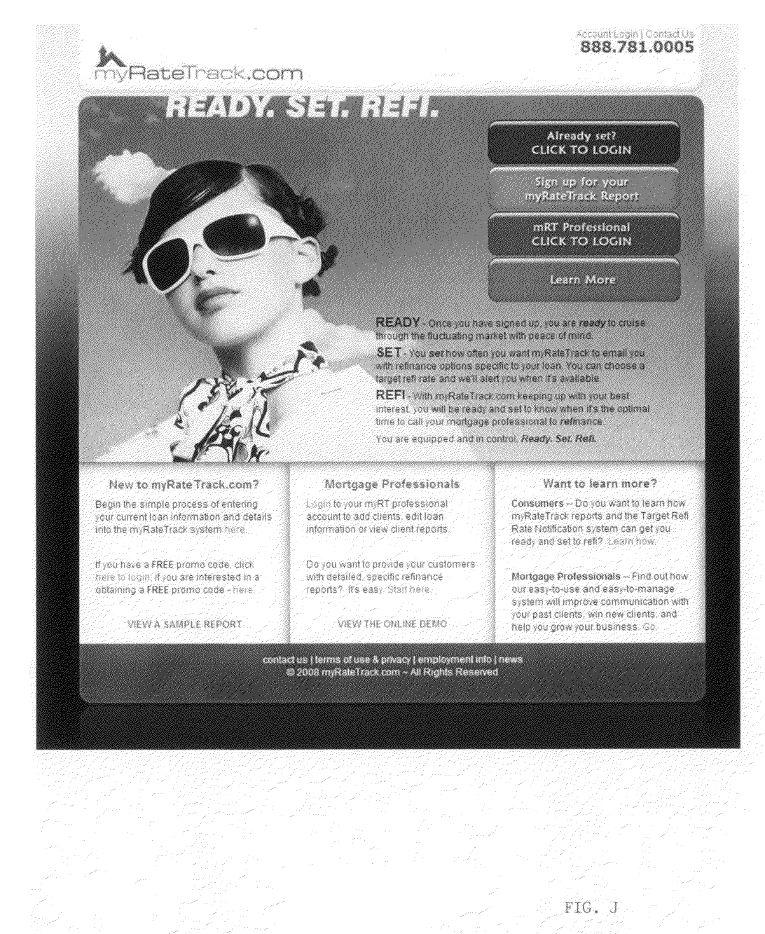

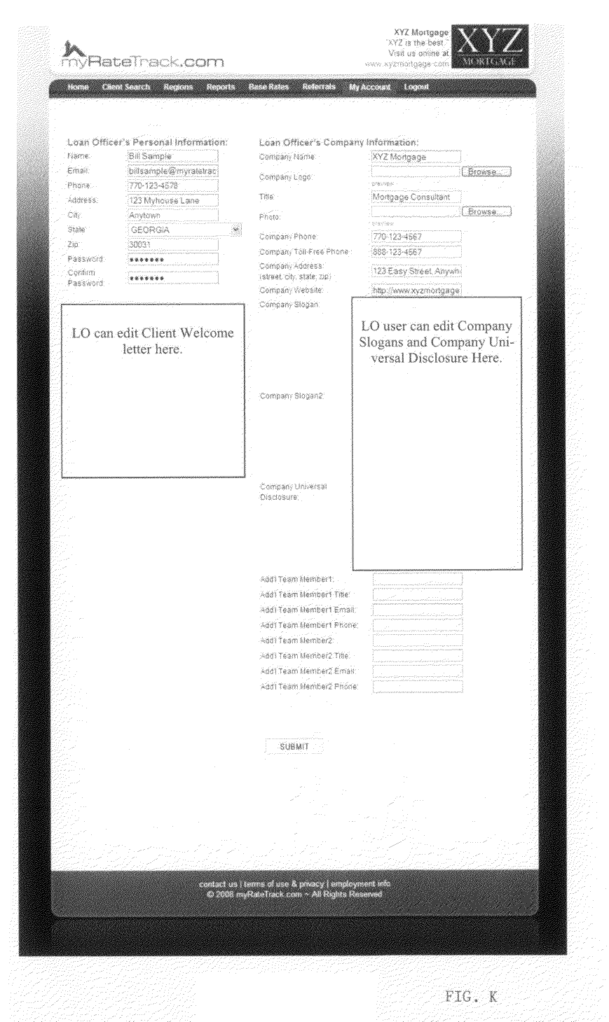

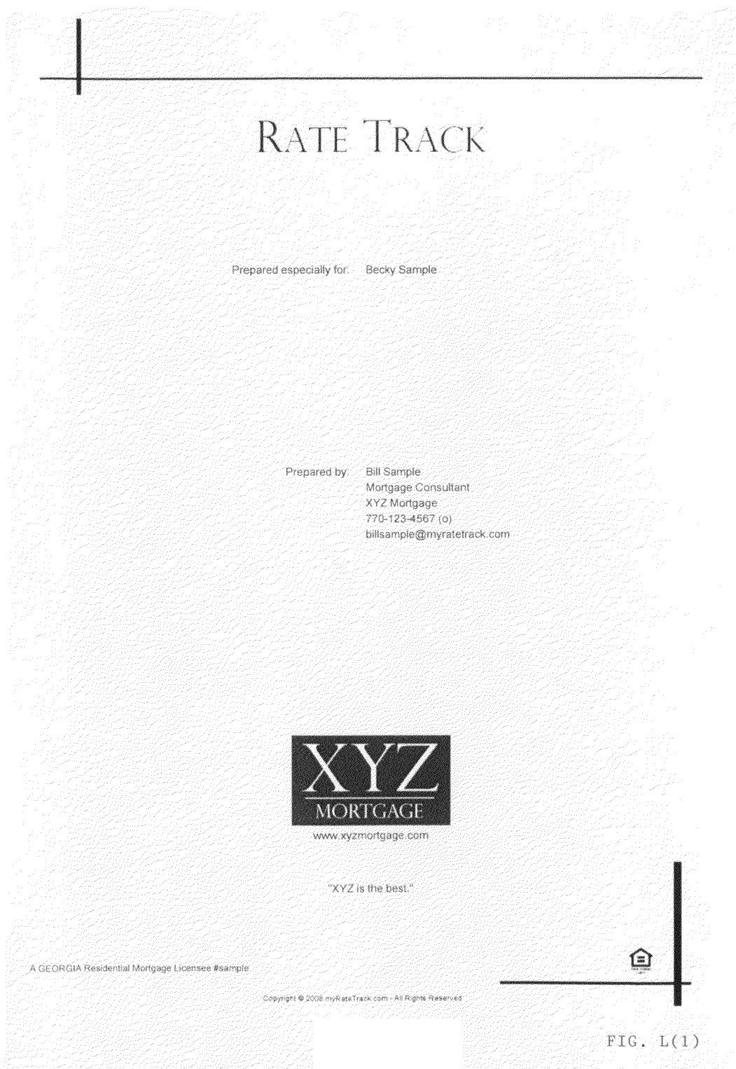

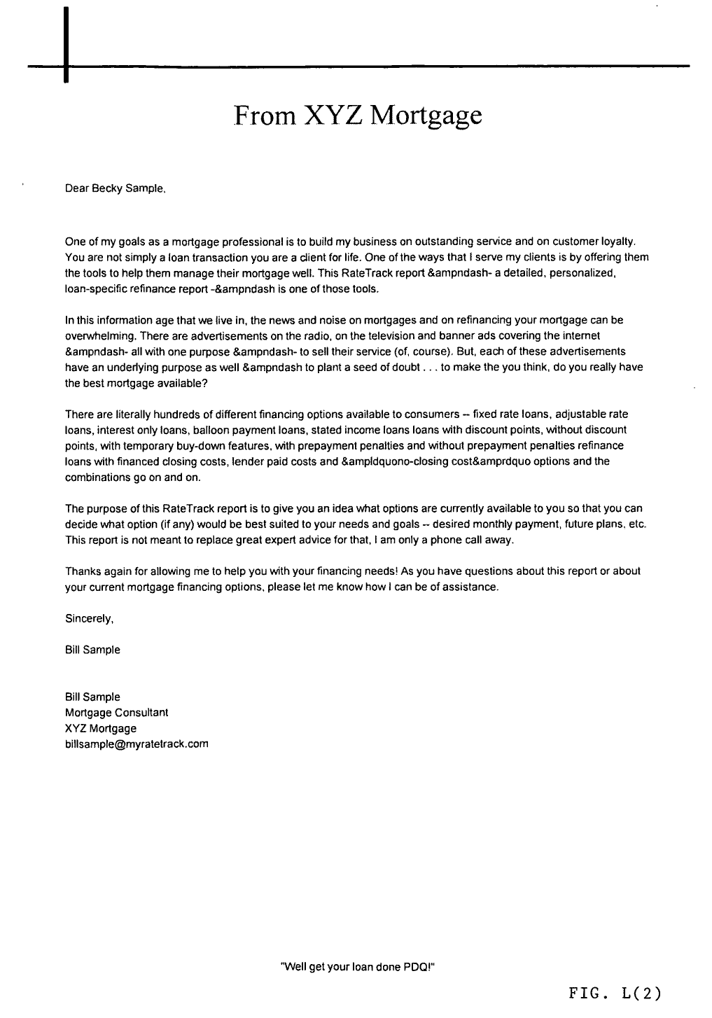

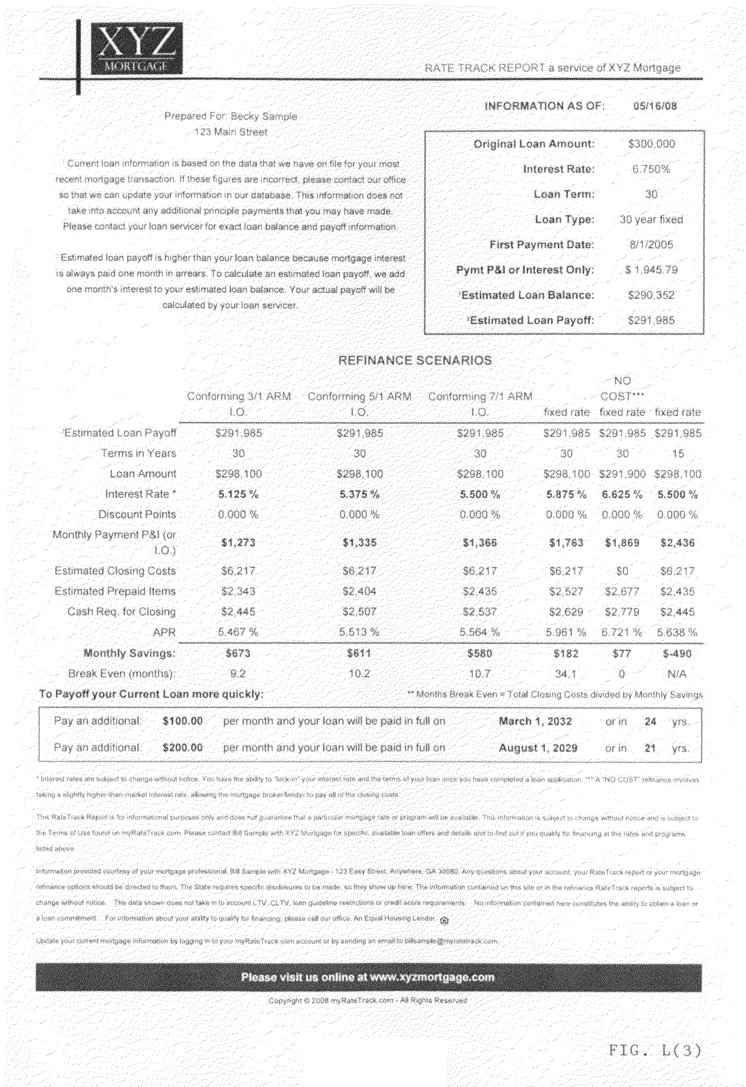

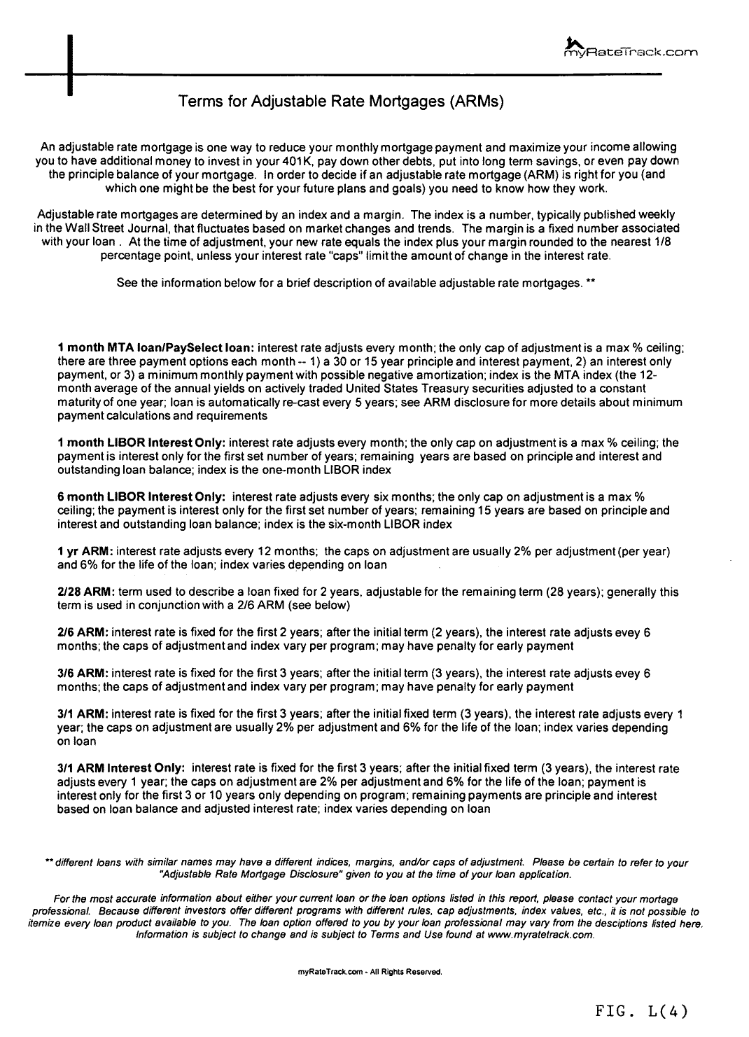

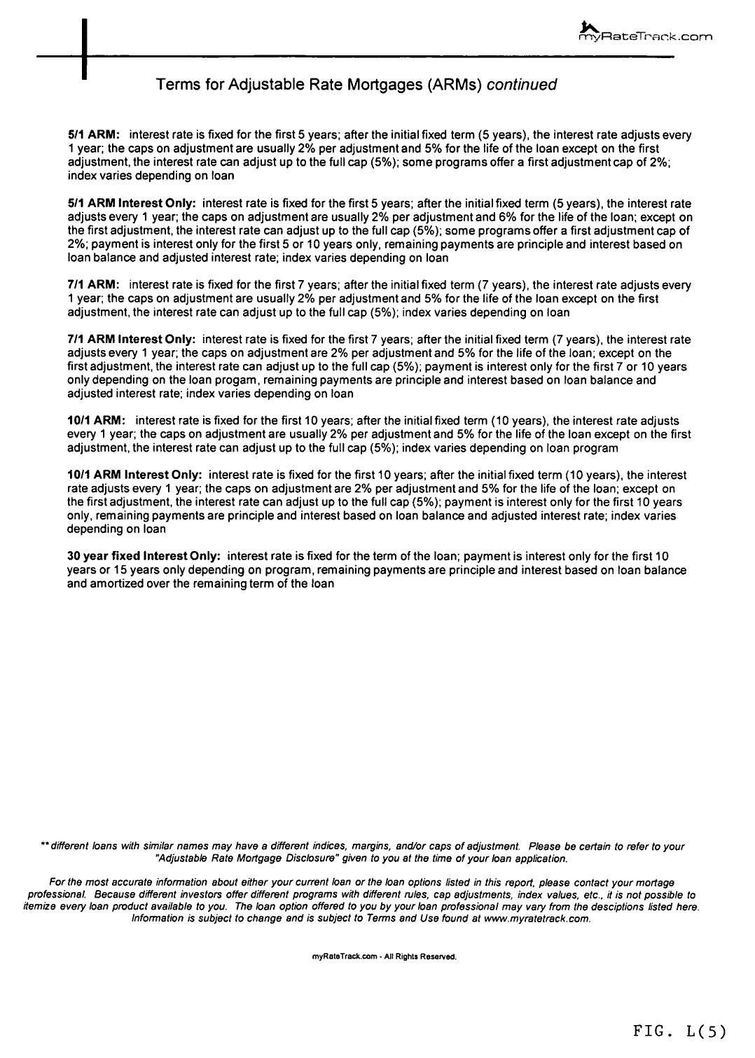

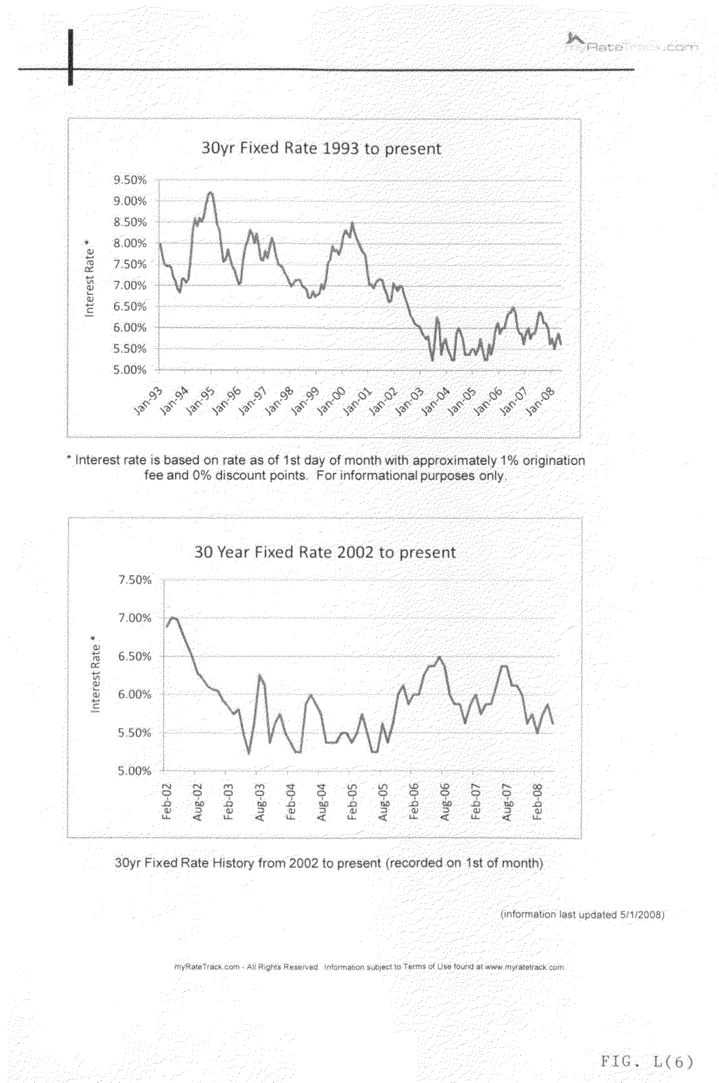

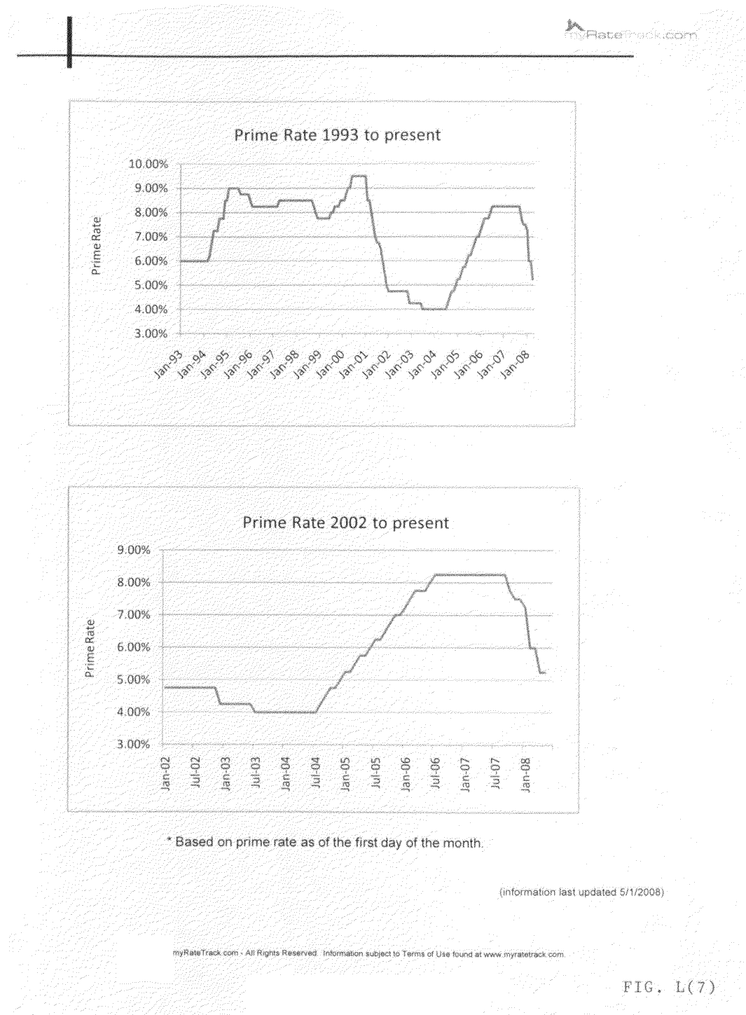

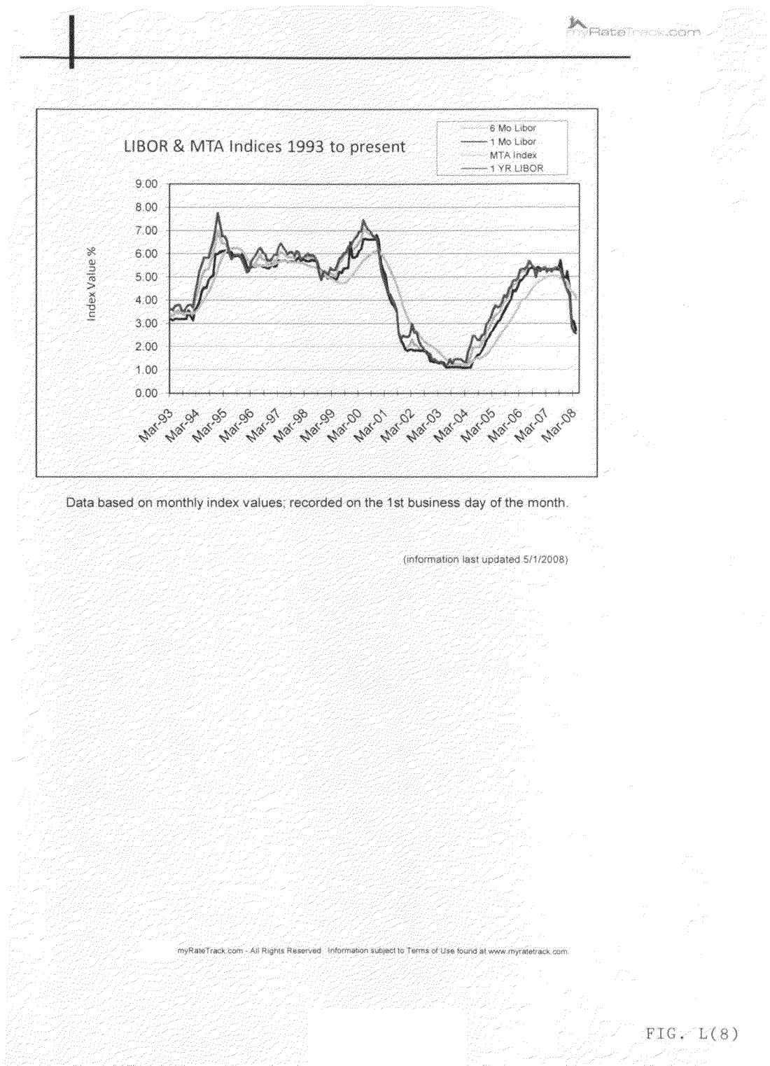

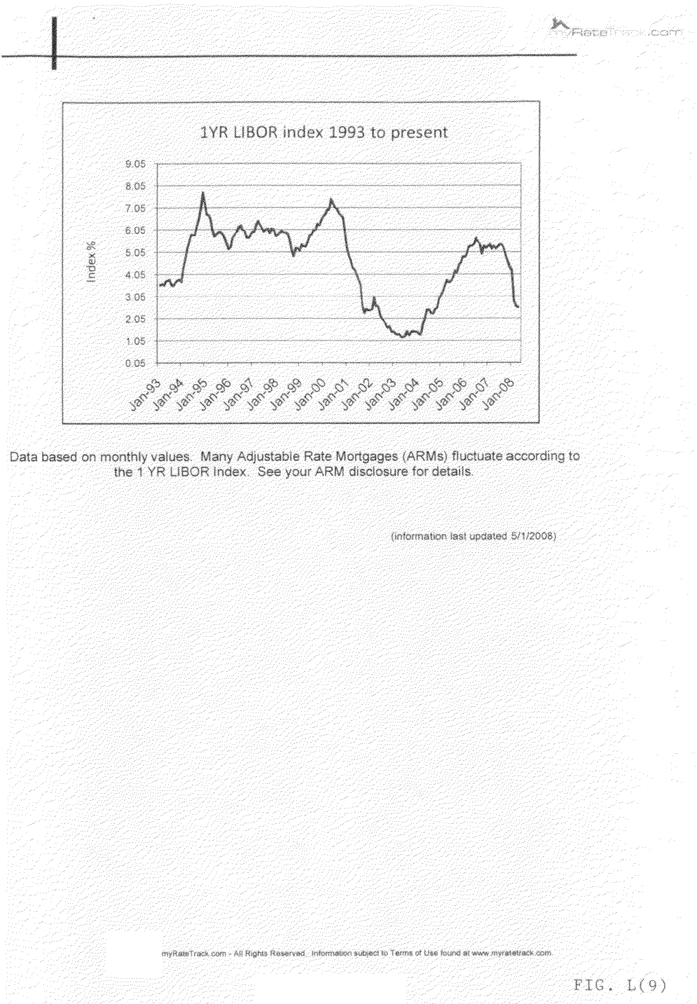

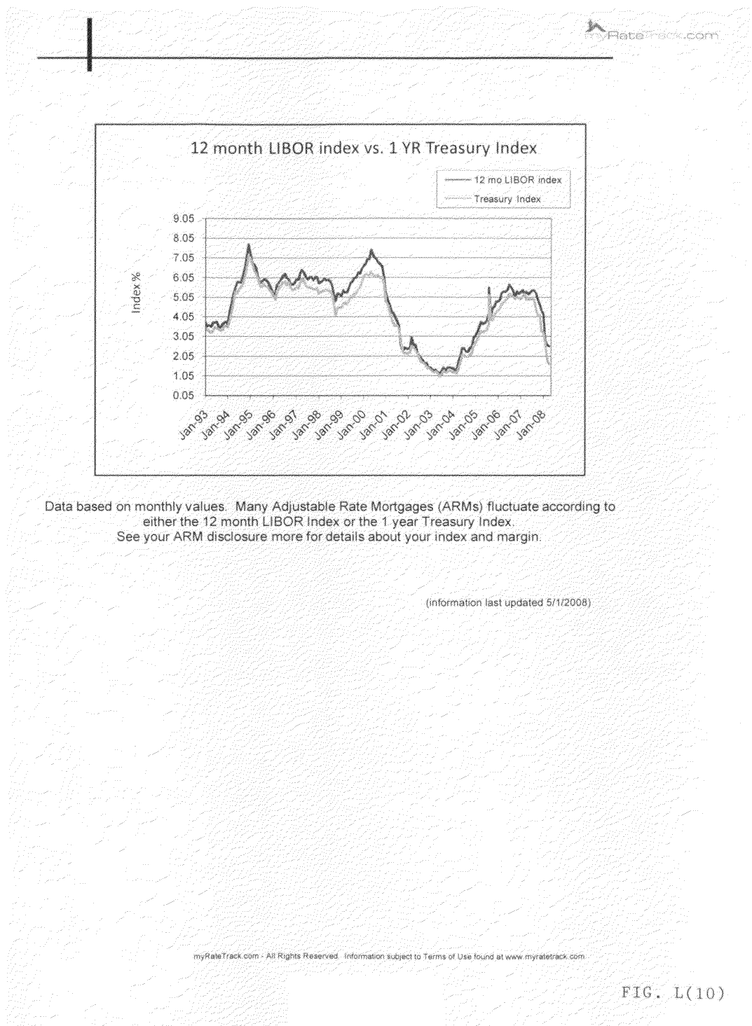

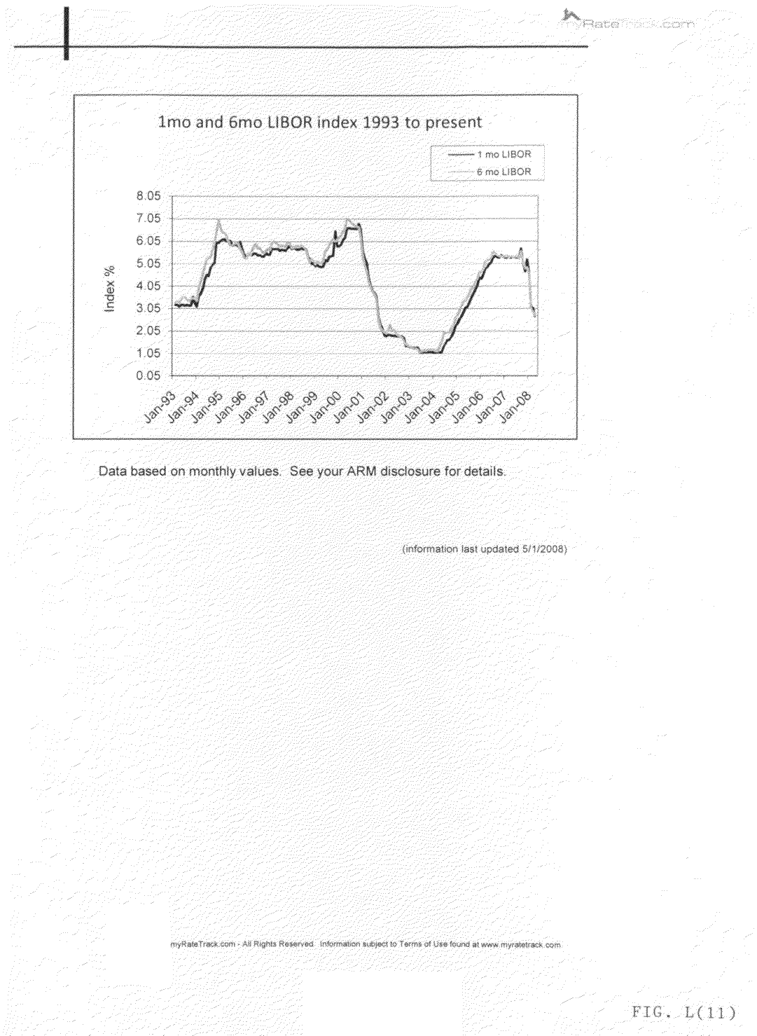

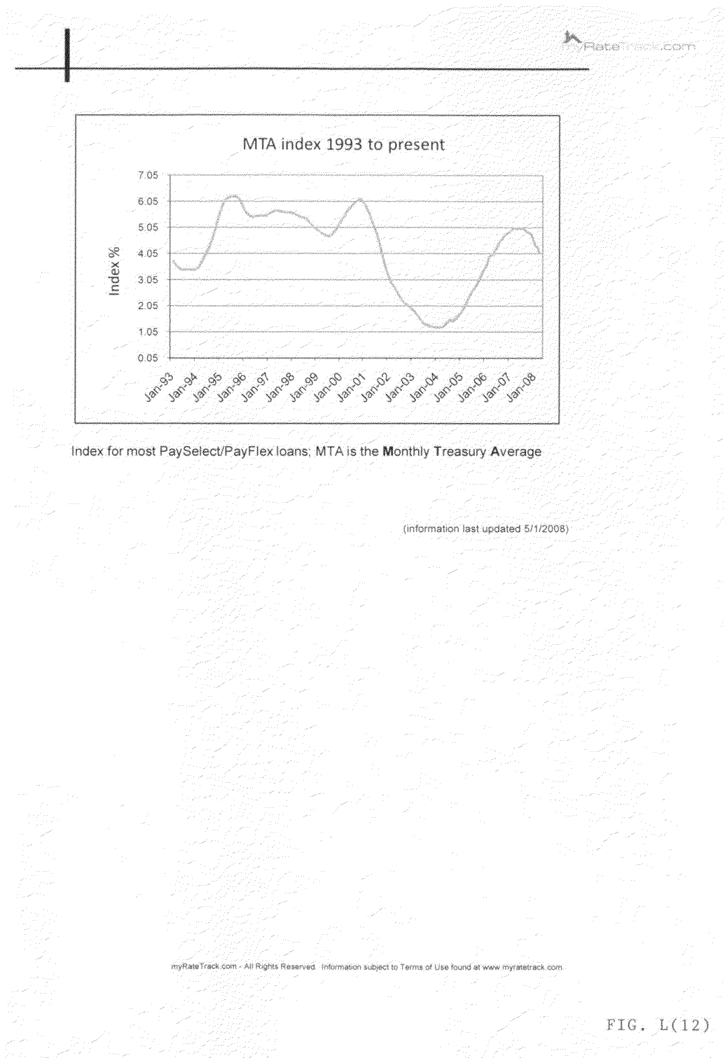

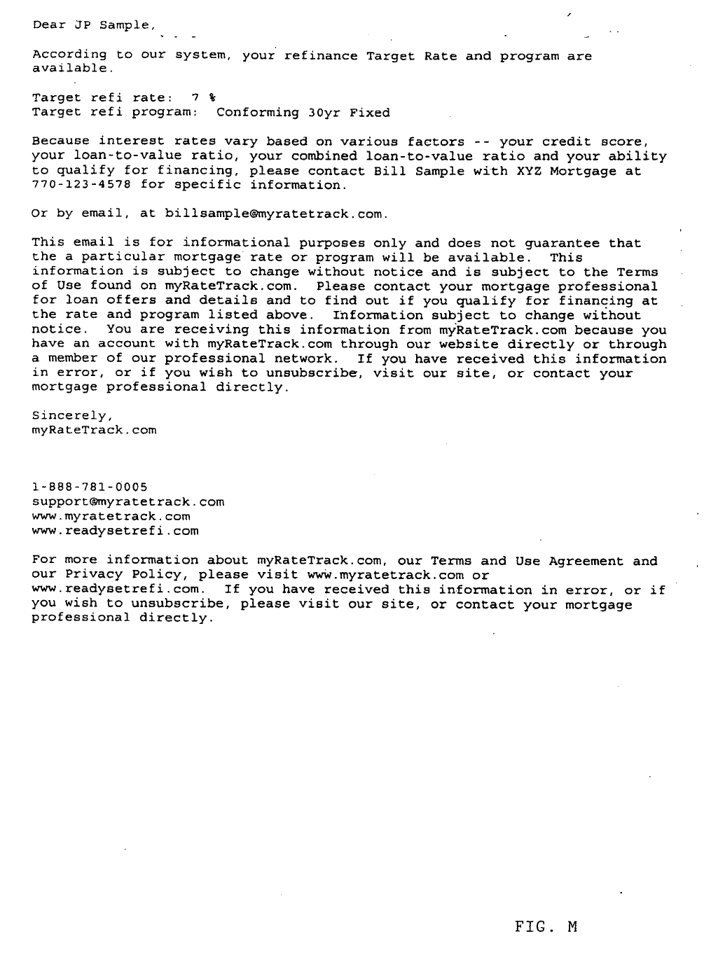

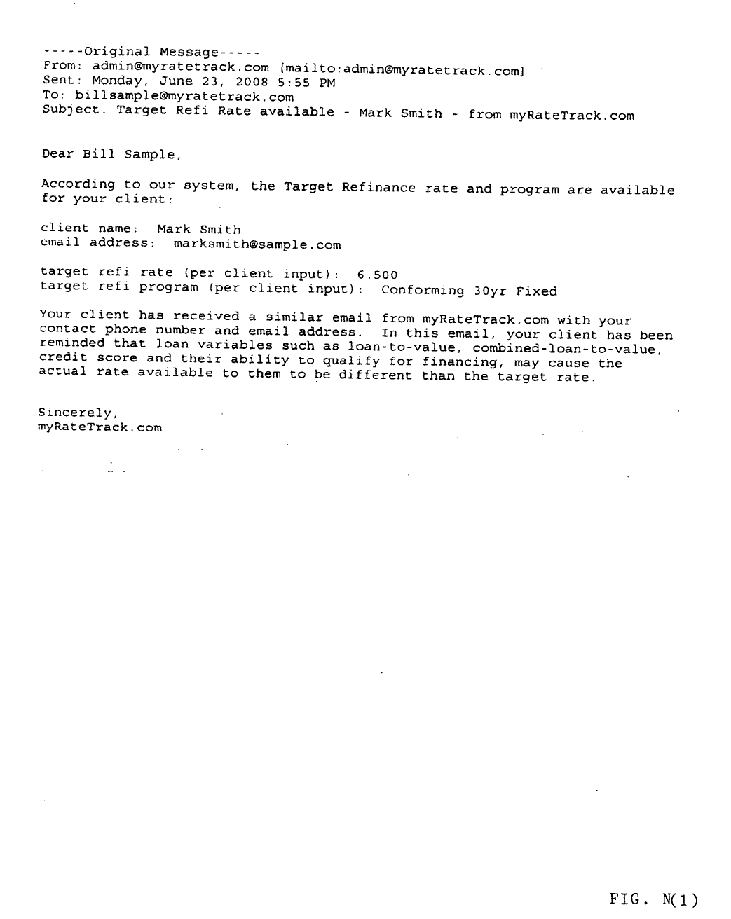

Referring now to FIG. 3, preferably the process of providing a mortgage loan notification and marketing system according to the present invention begins with a mortgage professional, client or individual accessing system 100 by logging into the web-based system through the internet (step 50) to establish a system account. For mortgage professionals, it may be necessary for the site administrator to establish the account, or the system provides an automated process of establishing a system account at the user interfaces. FIG. J shows an example user interface display that prompts a new user to enter the system to begin entering current loan information and details. Figure A shows an example user interface display that provides new or existing users with the ability to login to the system.

Referring back to FIG. 3, preferably at step 52 the site administrator or system interviews a mortgage professional regarding personal, marketing and other information for input into system 100. The requested information is then stored in the system. Preferably, this is facilitated by soliciting the mortgage professional's responses to a pre-fill form/questionnaire. This process can occur at an online location such as the mortgage professional's office or home.

The pre-fill form/questionnaire can be provided in hard copy or electronically. It can be supplied, for example, via stand-alone computer software (e.g., contained on media such as a CD-ROM or floppy disk and then stored on a hard disk), or over a telecommunications medium (e.g., over a global computer network such as the Internet). The pre-fill form/questionnaire can therefore be accessed on a stand-alone computer or a computer connected to a network which can be the Internet or a local or wide area dedicated or private network.

The inquiries made of the mortgage professional at step 52 can include for example: i) personal information, like name, email, phone, address, city, state, and zip code; ii) client welcome letter; iii) company information, like name, logo, title, photo, phone number, address, website, slogan, disclosures, and additional team members; iv) state-specific information like closing costs, and rate differentials; and v) other information including closing costs and interest rates calculations specific to the mortgage professional's business model. FIGS. B, C and K show example user interface displays and/or pre-fill form/questionnaires used to capture the mortgage professional's responses and information in accordance with the method of the present invention.

The information collected in step 52 is then saved by system 100 to the mortgage professional's system account. Preferably, system 100 uses the information provided in step 52 to create a customized web-based interface for the mortgage professional's clients to access through system 100. Each mortgage professional's client's interface can therefore incorporate the mortgage professional's marketing and contact information, like a welcome letter and introduction screen, while also providing detailed information like various loan programs that may be offered by that particular mortgage professional. Preferably, the mortgage professional's customized entries into the pre-fill questionnaire (step 52) will be incorporated by the system in the client website interface, as well as the generated notifications and refinance reports, as a means of marketing the mortgage professional's services to those clients.

The information inputted at step 52 may also be used by the system in the calculations process at step 62.

### Obtaining and Storing Existing Mortgage Information

Referring back to FIG. 3, preferably at step 56 system 100 interviews a mortgage professional about their clients' existing mortgage information, or an individual about their information, for input into the system. The requested information is then stored in the system. Preferably, this is facilitated by soliciting responses to a pre-fill form/questionnaire as set forth above.

The inquiries made of the user by the system at step 56 can include for example: i) Client or Individual Information, like name, email, phone number, property address, city, state, zip code, month to start refinance reports, mailer refinance report frequency, and promotional code; and ii) Existing Mortgage Information, like original loan amount, interest rate, loan term (in years), loan type, closing date, first payment date, whether the loan is interest only, property occupancy (whether a primary residence or investment property), ARM (“Adjustable Rate Mortgage”) loan, ARM index, ARM margin, ARM fixed term (months), ARM first adjustment date, ARM first cap, and additional principal paydown amount. FIG. H shows an example user interface display used to capture existing mortgage information in accordance with the method of the present invention.

Step 56 provides mortgage professionals or individuals with the ability to input existing mortgage loan and contact information. For example, if a mortgage professional has an existing client with a 30 year conventional mortgage loan at a 7% interest rate, the mortgage professional inputs that information into system 100. Preferably, step 56 captures a client's (or individual's) existing mortgage loan information, including the Original Loan Amount, Interest Rate, Loan Term, Loan Type, First Payment Date, whether the loan is an Interest Only Loan, whether the loan is an ARM Loan, ARM First Adjustment Date, Additional Principal Paid to Date, Property Occupancy (primary or investment), ARM Index, ARM Margin, ARM Fixed Term, and ARM First CAP. Other information that could be obtained includes second mortgage details, estimated property value, credit scores, and other factors important to mortgage professionals when assisting clients with mortgage finance options. The client's mortgage loan information is then stored in the mortgage professional's database of client information or the individual's account (as established at step 50).

FIG. G shows an example user interface display depicting existing mortgage information captured by the system in accordance with the method of the present invention.

Client or individual data can be input at step 56 in a number of ways. For example, the system provides the opportunity for the mortgage professional or individual to import an existing database of clients and mortgage information; input client information one at a time; or advertise special promotional codes to potential clients that allow clients to access the system free of charge and receive free refinance reports and notifications courtesy of the mortgage professional.

Mortgage professional clients using the promotional codes are then automatically added by the system to that mortgage professional's database of clients. As an added feature, the mortgage professional can use multiple promotional codes and associate those promotional codes with specific partners, like realtors, referral partners and others. For example, if a mortgage professional partnered with a financial planner, the financial planner could offer each of his clients customized refinance reports free of charge using the mortgage professional's promotional codes. The system provides the mortgage professional with the ability to associate specific promotional codes with marketing information, like banner advertisements, which the system can be directed to incorporate into the user interfaces, reports and notifications of the applicable clients. Thus, in the example above, the refinance reports sent to the financial planner's clients through the mortgage professional's promotional codes could be customized by the mortgage professional to include banner advertisements and other marketing information related to the financial planner or others.

It should be understood that when a new client or individual logs in to the system (step 50) and establishes an account that references a particular mortgage professional, that client is added to the mortgage professional's database of clients. The system then sends a notification to the mortgage professional, preferably by email, indicating that a new client has established an account to receive refinance notifications and reports under the mortgage professional's account. FIG. 0 is an example email notification to a mortgage professional acknowledging that a new client has signed up in the system to receive refinance notifications and reports pursuant to the mortgage professional's system account. It should also be noted that the FIG. O email provides the mortgage professional with the new client's name, email address, and the promotional code used by the client.

It should be understood that when a new client logs in to the system (step 50) and establishes an account, system 100 generates a notification, preferably by email, that is sent to the client confirming that they have established an account. FIG. P is an example email notification to a client confirming that the client has established an account. It should also be noted that the FIG. P email includes an internet website link that provides the client with the ability to login to the system and view a customized refinance report indicating available refinance options, as more fully set forth below.

It should be understood that when a mortgage professional inputs a new client into the system (step 50), system 100 generates a notification, preferably by email, that is sent to the client “courtesy of” the mortgage professional welcoming the client to the system and providing information, like username and password, and an internet website link that provides the client with the ability to view a customized refinance report indicating available refinance options, as more fully set forth below. FIG. R is an example email notification to a client “courtesy of” the mortgage professional welcoming the client to the system and providing the aforementioned information.

It should also be understood that individuals that are not clients of mortgage professionals may also create a login (step 50) and provide their existing mortgage loan information (step 56) and utilize the system as set forth below.

### Obtaining and Storing Desired Mortgage Loan Terms

Referring back to FIG. 3, preferably at step 58 the system interviews a client (or mortgage professional on behalf of the client) or individual about their desired or target mortgage loan terms. The requested information is then stored in the system. Preferably, this is facilitated by soliciting responses to a pre-fill form/questionnaire as set forth above.

The inquiries made of the user by the system at step 58 can include questions along the following lines, for example: 1) target (desired) refinance interest rate; and 2) target refinance loan program. FIG. 1 shows an example user interface display used to capture the desired or target mortgage loan refinance information in accordance with the method of the present invention.

Step 58 provides the person seeking to refinance or finance their loan (or the mortgage professional, on their client's behalf) with the opportunity to input into system 100 the loan terms that they desire. For example, if one currently has a 30 year fixed mortgage loan at a 7% interest rate, but is seeking a 30 year fixed mortgage loan at a lower rate of 6%, they can input into system 100 that they desire a 30 year fixed mortgage at a 6% interest rate.

It should also be understood that anytime a client that has established a system account referencing a particular mortgage professional makes a change to or updates their inputted desired loan information, the mortgage professional may receive a notification, preferably by email, detailing the changes. FIG. Q is an example email notification to a mortgage professional setting forth that a client changed the type of loan he is seeking to a conforming 30 year fixed loan at a 7% interest rate.

Preferably, once steps 50 through 58 are complete, system 100 will have a database of the mortgage professional's personal, company, and marketing information; their clients' existing loan information; and their clients' desired loan terms.

Furthermore, system 100's client interface can be branded specifically with that client's mortgage professional's marketing and contact information, including but not limited to photo, company logo, contact information, disclosures and slogans, providing the mortgage professional with the ability to market various services. FIG. F shows an example of a mortgage professional's client interface display that includes the mortgage professional's customized banner advertisement of a partner on the bottom, photo and contact information on the left side, and company logo and contact information in the top right corner, all in accordance with the method of the present invention. By way of example, the mortgage professional could incorporate a banner ad in the client interface regarding his own company or that of a referral partner, thereby marketing his or his partner's services.

It should be understood that much of the information inputted at steps 52 through 58 can be updated or changed by the mortgage professional, client, or individual by logging into the system and inputting the desired changes.

### Obtaining Mortgage Market Data

Referring now to FIG. 3, preferably at step 60, the retrieval of mortgage market data begins with either the system administrator inputting a multitude of interest rate information and other mortgage market variables into system 100 or the system automatically retrieving that information through the internet or otherwise. Desirably, mortgage market data is inputted into the system on a daily basis, or multiple times per day if market changes dictate that the base rate information should be updated more frequently. Desirably, mortgage market data input into the system at step 60 will include among others: 1) 1 year treasury index rate; 2) 12 month London Interbank Offered Rate (“LIBOR”) Index; 3) 6 Month LIBOR Index; 4) 1 Month LIBOR Index; 5) Prime Rate; 6) MTA Index; 7) Conforming 30 year fixed rate; 8) Conforming 30 year fixed interest only (“IO”) rate; 9) Conforming 15 year fixed rate; 10) Conforming 3/1 Adjustable Rate Mortgage (“ARM”) rate; 11) Conforming 3/1 ARM IO rate; 12) Conforming 5/1 ARM rate; 13) Conforming 5/1 ARM IO rate; 14) Conforming 7/1 ARM rate; 15) Conforming 10/1 ARM rate; 16) Conforming 10/1 ARM IO rate; 17) JUMBO 30 year fixed rate; 18) JUMBO 30 year fixed IO rate; 19) JUMBO 15 year fixed rate; 20) JUMBO 3/1 ARM rate; 21) JUMBO 3/1 ARM IO rate; 22) JUMBO 5/1 ARM rate; 23) JUMBO 5/1 ARM IO rate; 24) JUMBO 7/1 ARM rate; 25) JUMBO 7/1 ARM IO rate; 26) JUMBO 10/1 ARM rate; 27) JUMBO 10/1 ARM IO rate; 28) conforming 20 year fixed rate; 29) JUMBO 20 year fixed rate; and 30) other applicable indices and market variables. Desirably, the mortgage market data inputted at step 60 would represent the lowest interest rates available in the market (among many different lenders) that would be available to the mortgage professional. Once the base rate information is input into system 100, it is stored by the system.

FIG. D shows an example of the system administrator's interface display that can be used to input the mortgage market data set forth above into the system, all in accordance with the method of the present invention. Preferably, these market rates are updated daily (or as often as the market requires) by the system administrator or automatically by the system through computer software or the internet.

Referring back to FIG. 3, it should be understood that at step 52 the mortgage professional has the option of setting up an interest rate-differential per loan program, per state, that will be added to the system's mortgage market data (step 60), resulting in the actual interest rate that will be used in calculating the refinance options for that specific mortgage professional's clients, all as set forth below. For example, if the system base interest rate inputted by the system for a 30 year fixed rate loan is 5.75% (at step 60), but the mortgage professional's company is consistently offering rates at a higher amount in certain states, like 6.00%, the mortgage professional can set the rate differential for 30 year fixed rate loans to be +0.25% for that state, and the system will add 0.25% to the inputted base rate information when calculating refinance options and whether the client's desired loan terms are available for that mortgage professional's clients that are seeking loans in that particular state. According to the present invention, rate differentials can be customized by each mortgage professional by state and are based on the loan program, loan size, and other factors. FIG. C shows an example user interface display used to capture a mortgage professional's interest rate differentials in accordance with the method of the present invention.

### Calculating Available Loan Terms

Referring now to FIG. 3, preferably at step 62 the available loan term calculation process begins when system 100 is manually or automatically prompted to perform a variety of mortgage calculations to determine finance or refinance options based on the information inputted in steps 52 through 60. Desirably, these calculations are performed by the system on a daily basis, or multiple times per day if market changes or changes to client or individual information dictates that the calculation should be performed more frequently. The referred to calculations made by system 100 include, but are not limited to: 1) Estimated Loan Balance; 2) Estimated Loan Payoff; 3) Terms in Years; 4) Loan Amount; 5) Interest Rate; 6) Discount Points; 7) Monthly Principal and Interest (“P&I”) or Interest Only (“10”) Payment; 8) Estimated Closing Costs; 9) Estimated Prepaid Items; 10) Cash Required for Closing; 11) Annual Percentage Rate; 12) Monthly Savings; 13) Months to Recoup Closing Costs (“break even (months)”); and 14) Revised Payoff Time.

The Estimated Loan Balance is preferably calculated by the system by utilizing an amortization schedule of an inputted existing loan (step 56). The system calculates the estimated loan balance based on the client's or individual's existing mortgage interest rate and existing mortgage loan information (as inputted at step 56) for the day the system is prompted to make the calculation. As time progresses, and the loan balance is presumably paid down or affected in other ways, the system calculates the revised balances pursuant to the information inputted at step 56.

The Estimated Loan Payoff is preferably calculated by the system by adding one month's worth of interest (as inputted at step 56) to the Estimated Loan Balance (because mortgage interest is paid in arrears, lenders charge consumers this interest at the time of paying off their mortgages).

The Term in Years is preferably determined by the system to be the number of years (or term) for each loan program. For example, a conforming 3/1 ARM I.O. loan program is a 30 year loan program, and the system is programmed such that the calculations for a 3/1 ARM I.O include a term in years of 30 years.

The Loan Amount is preferably calculated by the system by adding the closing costs associated with the potential new refinanced loan (as inputted at step 52) to the Estimated Loan Payoff. It should be understood, however, that at step 52, the mortgage professional has the option of choosing a “no cost” closing cost option which results in the system calculating the Loan Amount to be equal to the Estimated Loan Payoff (though this typically results in a corresponding higher interest rate that may be inputted by the mortgage professional as a rate differential. See FIG. C).

The Interest Rate is preferably calculated by the system by adding the inputted base rate information (step 60) to the mortgage professional's inputted rate-differential (step 52). The Interest Rate calculation by the system may also be affected by the inputted client's (or individual's) existing mortgage information, state-specific factors, closing cost information, and other information inputted at steps 52 through 60.

The Discount Points is preferably determined by the system to be the value inputted into the system at step 52.

The Monthly P&I or IO Payment is preferably calculated by the system in one of two ways: 1. If the loan option for the refinance scenario is a principle and interest payment, the monthly P&I is determined by a mortgage amortization schedule based on the Loan Amount, Interest Rate and Loan Term; 2. If the loan option for the refinance scenario is an interest-only loan, the monthly interest only payment is calculated by multiplying the Loan Amount by the Interest Rate and dividing the result by twelve ((Loan Amount×Interest Rate)/12) to determine a monthly interest payment.

The Estimated Closing Costs is preferably determined by the system to be the sum of the Appraisal Fee, Credit Report Fee, Underwriting/Administration Fee, Processing Fee, other miscellaneous fees, Attorney Fee, Title Search Fee, and other settlement fees plus the Origination Fee (Loan Amount times the inputted percent), Discount Points (Loan Amount times the inputted percent), Title Insurance Factor (Loan Amount times the inputted percent), and State Intangible Factor (Loan Amount times the inputted state percent), all as inputted into the system at step 52.

The Estimated Prepaid Items is preferably calculated by the system to be the sum of 30 days of per diem interest on the new mortgage and an estimate of funds needed to establish an escrow account for taxes and insurance under the new proposed mortgage. The Property Tax Factor and Hazard Insurance Factor as inputted into the system at step 52 are used to estimate a monthly insurance amount and a monthly property tax amount for the client. The total Estimated Prepaid Items is determined by a calculation commonly used in the mortgage refinance industry. The Property Tax Factor, Hazard Insurance Factor, and Interest Factor are determined by formulas commonly used in the mortgage industry and the information inputted at steps 52 through 60.

The Cash Required for Closing is preferably calculated by the system by adding the Estimated Loan Payoff, Estimated Closing Costs, and Estimated Prepaid Expenses, minus the Loan Amount.

The APR (“Annual Percentage Rate”) is preferably calculated by the system by utilizing formulas commonly used in the mortgage refinance industry and the information inputted at steps 52 through 60.

The Monthly Savings is preferably calculated by the system by subtracting the Monthly P&I or IO Payment from the existing mortgage payment information inputted at step 56.

The Break Even is preferably calculated by the system by dividing the Estimated Closing Costs by the Monthly Savings.

The Revised Payoff Time, which is a calculation setting forth the reduction in the time it will take to fully pay off a loan if additional principal payments are made on a monthly basis, is preferably calculated by the system by applying an amortization schedule to the existing loan that encompasses additional principal payments above those set forth in the Monthly P&I Payment. The system then calculates the date that the principal balance would be paid in full if the additional principal payments are made.

It should be understood that the system according to the present invention is capable of making the aforementioned calculations and other calculations so as to assemble multiple refinance options or scenarios, like varying loan programs or terms, and determine whether the desired loan information exists for each client or individual.

It should be understood that the system is capable of making additional calculations based on the inputted existing mortgage information, state-specific factors, and closing cost information (steps 52 through 58), mortgage market data (step 60) and other information, according to the system and process of the present invention. These can include, without limitation, calculations related to adjustable rate mortgages (“ARM”), including but not limited to the Anticipated Loan Information at Adjustment, Anticipated Loan Balance, Fully Adjusted Rate, Term After Adjustment, Anticipated Interest Rate (based on the base rate information inputted at step 60), Monthly P&I Payment, the Estimated Change in Payment, and other calculations.

Referring back to FIG. 3, preferably at step 64 system 100 according to the present invention uses the aforementioned calculations (step 62) and the inputted existing mortgage information, state-specific factors, and closing cost information (steps 52 through 58), mortgage market data (step 60) and other information to determine if loan terms are available that are equal to or more favorable than an individual's desired mortgage terms (as inputted in step 58). For example, if an individual inputs that they desire a 30 year conventional mortgage with a fixed interest rate of 6% and that their existing mortgage is a 30 year conventional fixed mortgage at a 7.5% interest rate, each time the mortgage market data is adjusted, or anytime the system is prompted, the system will evaluate whether the desired mortgage option exists, or whether any mortgage option exists that is equal to or more favorable than the desired mortgage terms.

### Automatic Notification of Available Desired Loan Terms

Referring back to FIG. 3, preferably at step 66, if the system determines at step 64 that a desired mortgage option exists, or that a mortgage option exists that is equal to or more favorable than the inputted desired mortgage terms (step 58), system 100 generates an automatic notification that is sent directly to a client or individual and the mortgage professional via email or otherwise. Desirably, the notification is sent by system 100 via email.

It should be understood that the inventive system at steps 52 through 58 allows the mortgage professional or client/individual to target certain factors, like a desired interest rate or loan program, that depending upon market variables, may make refinancing beneficial for the client. If a certain interest rate or loan program becomes available (based on the information inputted and calculations made at steps 52 through 62) that meets or exceeds the desired loan terms set forth in step 58, the system generates an email to the client indicating that a target refinance parameter has been met. For example, if a client inputs at step 58 that they desire a 30 year conventional mortgage with an interest rate of 6%, the system will generate an e-mail as set forth above when the system calculates at step 62 that a 30 year conventional mortgage is available at 6% (or lower like 5.75%).

The email notification may also include a mortgage professional's contact information and a suggestion that they call their mortgage professional. The system also generates a similar email that is sent directly to the mortgage professional informing them that one of their client's target refinance parameters has been met. This email also provides the mortgage professional with their client's contact information and a suggestion that they contact the client.

FIG. M shows an example of an email notification to a client or individual indicating that their desired refinance rate and/or loan program (as inputted at step 58) is available. It should also be noted that FIG. M directs the client or individual to contact their mortgage professional at the contact information inputted by the mortgage professional at step 52.

FIG. N shows an example of an email notification to a mortgage professional indicating that a client's target refinance rate and/or loan program (as inputted at step 58) is available.

It should also be understood that the system automatically generates the aforementioned notifications (step 66) without the mortgage professional or individual having to take additional action (aside from inputting the information at steps 52 through 58). As a result, the system provides the mortgage professional with a tool that automatically notifies the mortgage professional's clients that are inputted into the system, along with the mortgage professional, when a client's desired loan terms are available.

It should be understood that an individual that has accessed the system and does not have a mortgage professional is also able to set up an account and receive automated refinance notifications and reports and otherwise utilize the system as set forth above and below.

Referring back to FIG. 3, preferably at step 72, after the automated notifications at step 66 are sent, or if at step 64 the system determines that no finance/refinance options exist that meet the desired loan information inputted at step 58, the system proceeds to step 74, as set forth below.

### Automatic Generation of Refinance Reports

Referring back to FIG. 3, preferably at step 68, the system determines whether a client or individual has requested the system to automatically generate a refinance report detailing refinance options available on the date the report is requested.

The refinance report is a report detailing loan programs and scenarios that are available on the date the report is requested (based on that day's inputted mortgage market data and other market variables—step 60), as calculated by the system at step 62. FIG. L shows an example of a refinance report which sets forth some of the results of the calculations and determinations made by the system at step 62, including but not limited to the Estimated Loan Balance, Estimated Loan Payoff, Terms in Years, Loan Amount, Interest Rate, Discount Points, Monthly P&I (or IO) Payment, Estimated Closing Costs, Estimated Prepaid Items, Cash Required for Closing, APR, Monthly Savings, Break Even, and To Payoff you Current Loan More Quickly. FIG. T shows an example of an additional report that may be part of the refinance report when the client's existing mortgage information (inputted at step 56) includes an adjustable rate mortgage. FIG. T sets forth some of the results of the calculations and determinations made by the system at step 62, including but not limited to the Anticipated Loan Balance, Fully Adjusted Rate, Term After Adjustment, Anticipated Interest Rate, Monthly P&I, and Estimated Change in Payment (per month).

It should be understood that at step 56 or 58, a client, mortgage professional, or individual can prompt the system to automatically generate and deliver notifications of a refinance report at regular intervals, for example weekly, bimonthly, monthly, quarterly or otherwise. Additionally, if a client, mortgage professional, or individual would like to request a refinance report on a day other than those set forth in step 56 or 58, the system provides the client or individual at the user interface with the ability to request a refinance report at any time.

FIG. I shows an example user interface display used to capture the frequency at which the user would like to receive a refinance report.

FIG. F shows an example user interface that provides a web site link (“Generate My Rate Track Report”) that if initiated will provide the user with a refinance report instantly as set forth above.

Referring back to FIG. 3, when the system determines at step 68 that a refinance report has been requested, preferably the system proceeds to step 76 resulting in the system automatically generating a notification, by email or otherwise, to the client or individual setting forth that a refinance report is available and providing a means of viewing the refinance report. Desirably, the aforementioned notification is sent by system 100 via email.

FIG. S shows an example of an email notification to a client setting forth that a personalized refinance report is available for the client to view. FIG. S also includes an internet website link that provides the recipient with the ability to view the subject refinance report.

It should be understood that the system is also able to make calculations and generate refinance reports for clients or individuals with unconventional loans like adjustable rate mortgages (“ARM”). For example, based on the information entered at steps 56 through 60, the system calculates a client's or individual's potential interest rate and monthly payment if their ARM were to adjust as of the day the report is run (based on the day's index and the margin and caps of adjustment associated with that specific ARM) (as inputted at step 60). The resulting refinance report sets forth the aforementioned calculations, including but not limited to the Estimated Change in Payment (the amount the client will be paying when the adjustable rate mortgage adjusts minus the amount they were paying before the adjustment). FIG. T is an example of such a report.

Referring back to FIG. 3, preferably at step 78, after the automated notifications at step 76 are sent, or if at step 68 the system determines that a refinance report was not requested, the system proceeds to step 74, as set forth below.

Referring to FIG. 3, preferably at step 74 system 100 begins the processes outlined in FIG. 3 anew, beginning at step 52, 56, or 58 if new or revised information is entered or the system is scheduled to restart, or at step 60 when new mortgage market data is inputted into system 100.

Referring back to FIG. 3, steps 62 through 78 are preferably executed by software resident on server 12.

In one embodiment of the present invention, database 20 of system 100 can store a matrix of all possible combinations of question responses (steps 52 through 60) and calculations (step 62) to determine if the desired loan terms exist (step 64) and the available refinance options (step 76).

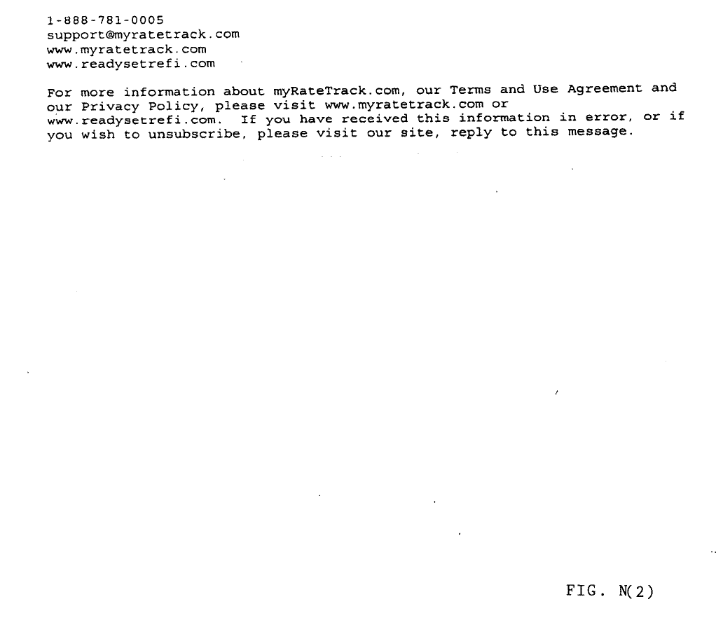

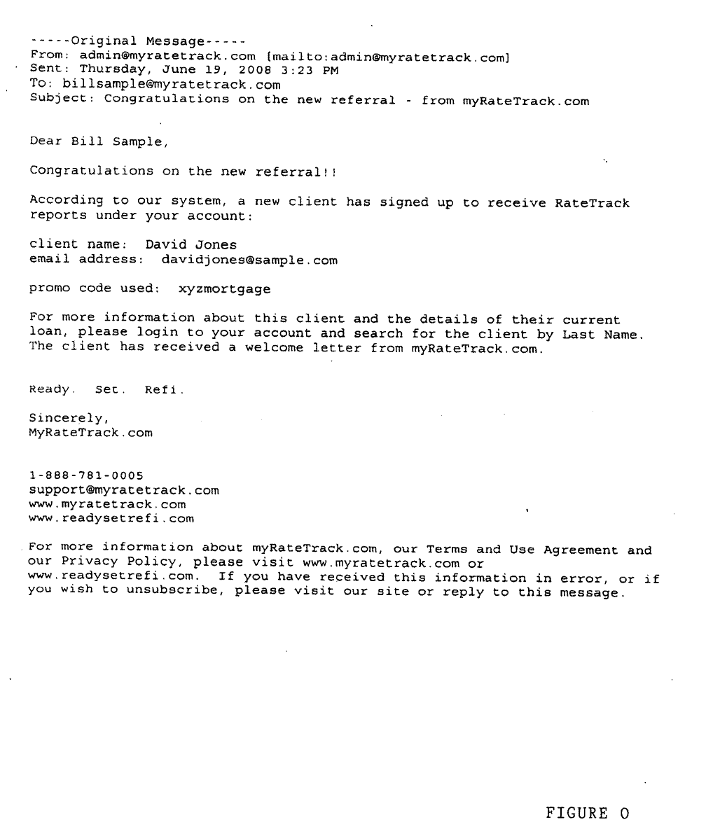

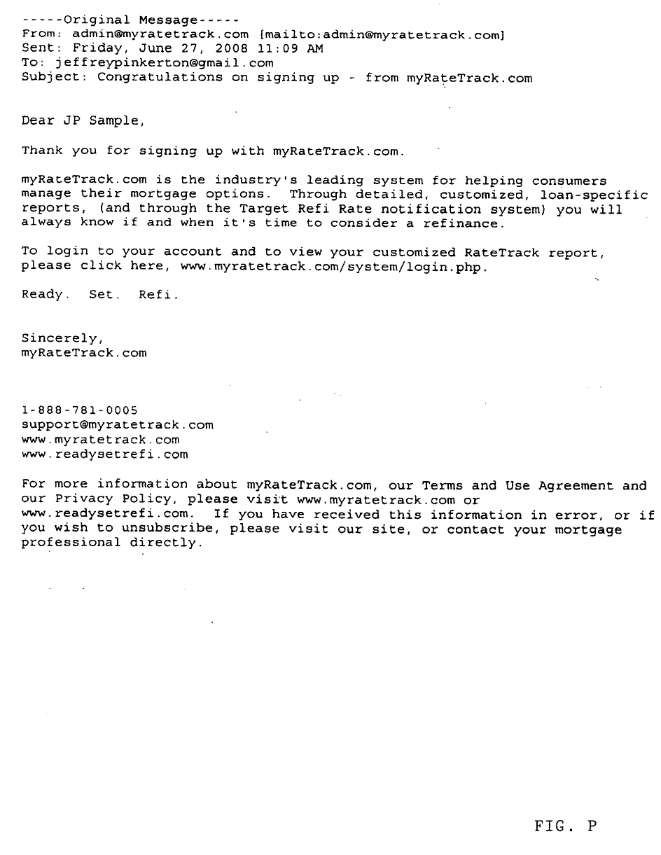

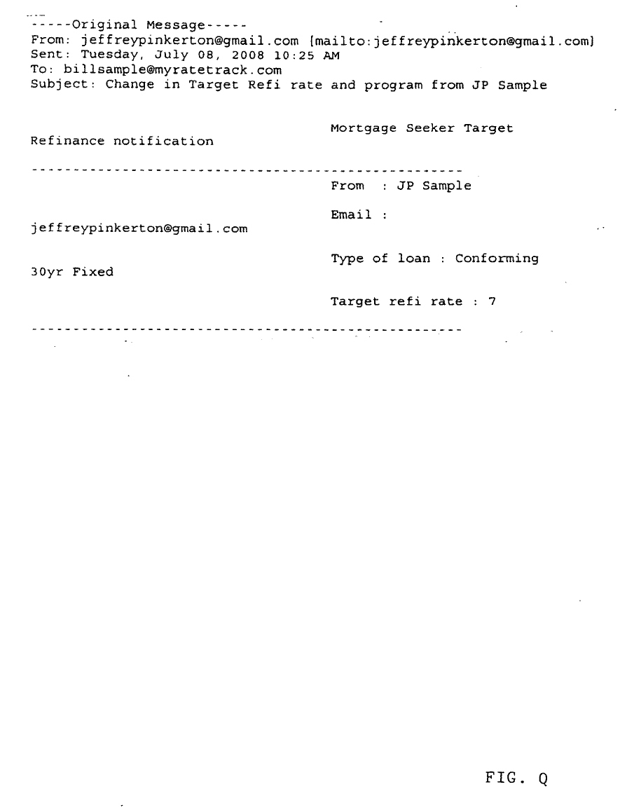

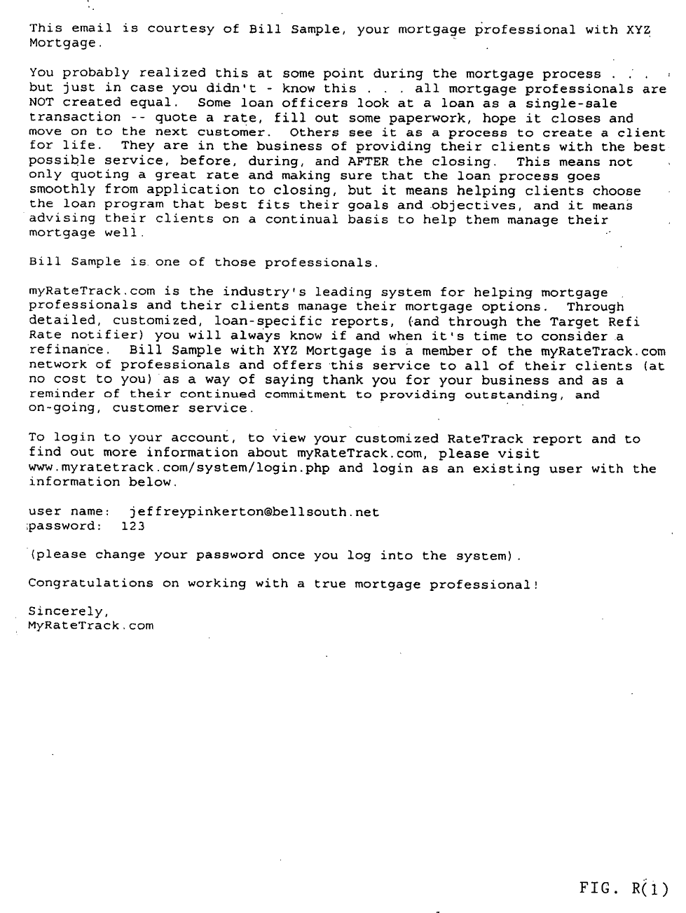

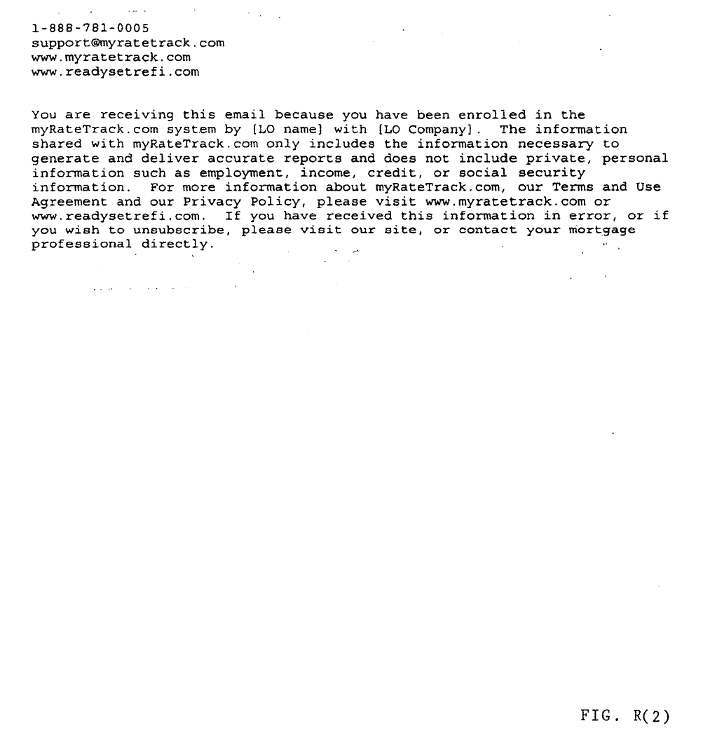

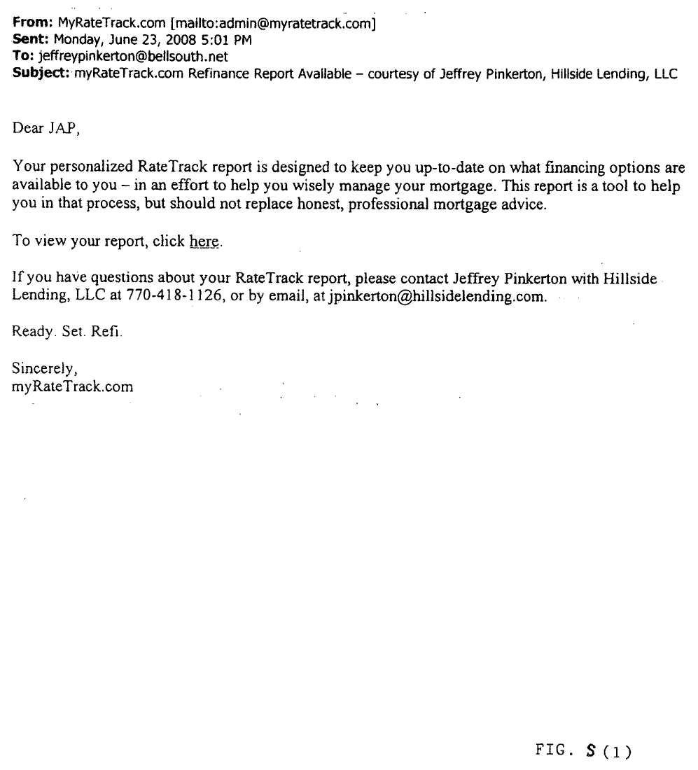

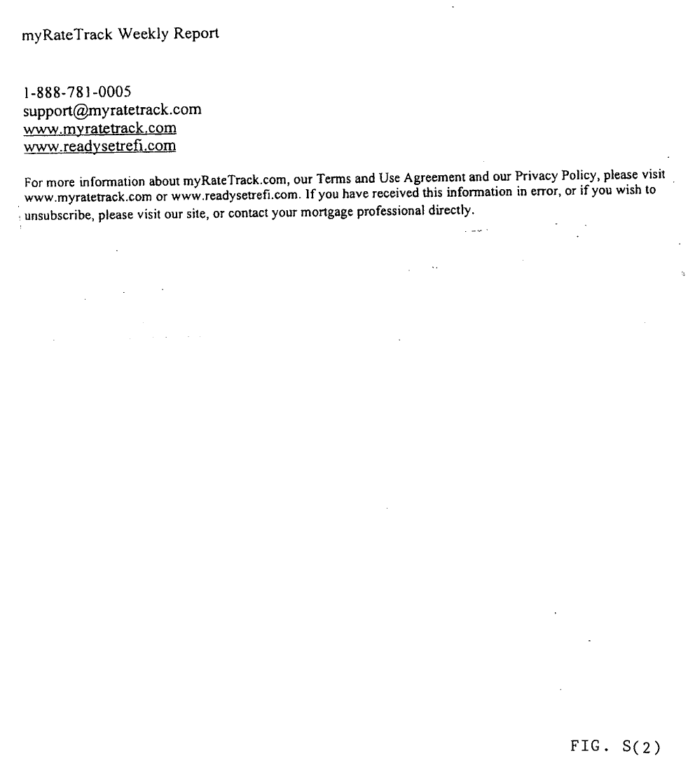

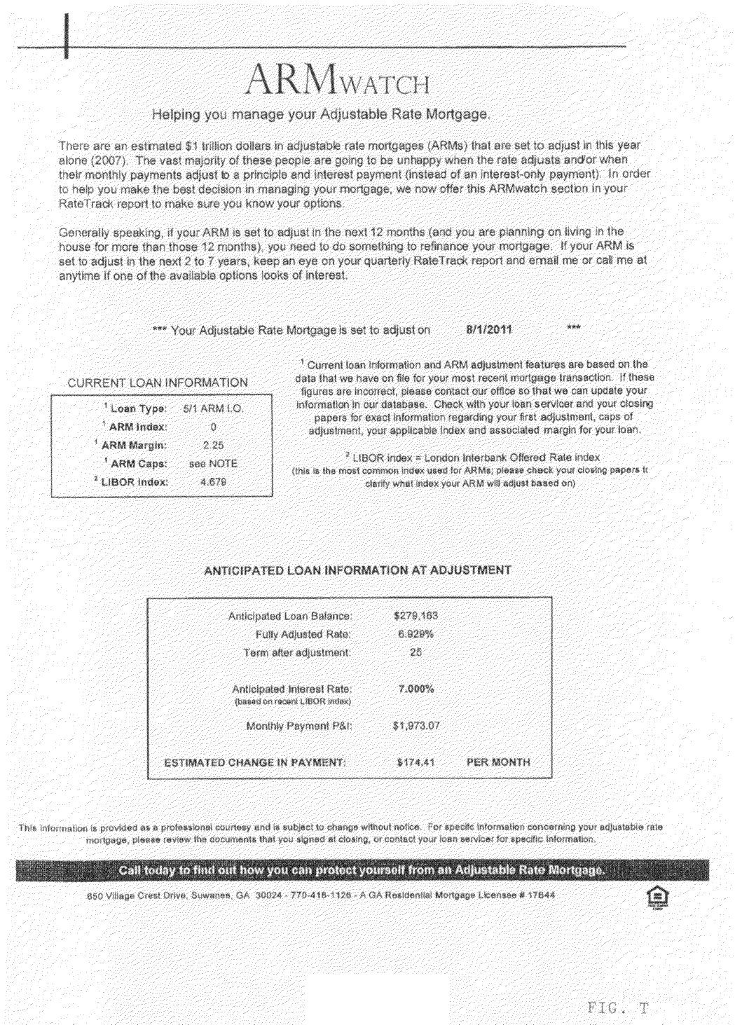

Referring now to FIG. 4, FIG. 4 sets forth an additional flow chart of “inputs” and “outputs” that provides further support of the aforementioned process of providing mortgage loan and marketing information according to the present invention.

In so far as embodiments of the invention described herein can be implemented, at least in part, using software controlled programmable processing devices, such as a computer system, it will be appreciated that one or more computer programs for configuring such programmable devices or system of devices to implement the foregoing described methods are to be considered as an aspect of the present invention. The computer programs can be embodied as source code and undergo compilation for implementation on processing devices or a system of devices, or can be embodied as object code, for example. Those of ordinary skill will readily understand that the term computer in its most general sense encompasses programmable devices such as those referred to above, and data processing apparatus, computer systems and the like.

Preferably, the computer programs are stored on carrier media in machine or device readable form, for example in digital, solid-state memory or magnetic memory such as disk or tape, and processing devices utilize the programs or parts thereof to configure themselves for operation. The computer programs can be supplied from remote sources embodied in communications media, such as electronic signals, radio frequency carrier waves, optical carrier waves and the like. Such carrier media are also contemplated as aspects of the present invention.

It will thus be seen that the objects set forth above, among those made apparent from the preceding description, are efficiently attained and, because certain changes can be made in carrying out the above method and in the constructions set forth for the system without departing from the spirit and scope of the invention, it is intended that all subject matter contained in the above description and shown in the accompanying drawings shall be interpreted as illustrative and not in a limiting sense.

It is also to be understood that the claims are intended to cover all of the generic and specific features of the invention herein described, and all statements of the scope of the invention which, as a matter of language, might be said to fall therebetween.

What is claimed is:

1. A computer-implemented method for providing individuals with an automated notification that desired mortgage loan terms are available, comprising the steps of: obtaining an individual's desired loan terms; storing an individual's desired loan terms; obtaining mortgage market data; processing the desired loan terms and mortgage market data to determine if an individual's desired loan terms are available; and sending an automated notification to the individual if their desired loan terms are available.

2. The method of claim 1 wherein the automated notification is sent to the individual by email.

3. The method of claim 1 further comprising the step of sending an automated notification to a mortgage professional if a client's desired loan terms are available.

4. The method of claim 3 wherein the automated notification is sent to the mortgage professional by email.

5. The method of claim 1 further comprising the step of obtaining and storing an individual's existing mortgage information.

6. The method of claim 1 further comprising the step of processing the desired loan terms and mortgage market data to determine the available loan terms.

7. The method of claim 6 further comprising the step of generating a mortgage loan report setting forth the available loan terms.

8. The method of claim 6 further comprising the step of sending an automated notification to the individual that a mortgage loan report is available.

9. The method of claim 8 wherein the automated notification is sent to the individual by email.

10. The method of claim 7 further comprising the step of providing to an individual the mortgage loan report setting forth the available loan terms.

11. The method of claim 5 further comprising the step of processing the desired loan terms, mortgage market data and an individual's existing mortgage information to determine available loan terms.

12. The method of claim 11 further comprising the step of generating a mortgage loan report setting forth the available loan terms.

13. The method of claim 11 further comprising the step of sending an automated notification to the individual that a mortgage loan report is available.

14. The method of claim 12 further comprising the step of providing to an individual the mortgage loan report setting forth the available loan terms.

15. The method of claim 11 wherein the processing comprises the following calculations: estimated existing loan balance, estimated existing loan payoff, available loan term, available loan amount, available interest rate, available discount points, available monthly principal and interest payment, available interest only payment, available estimated closing costs, available estimated prepaid items, available cash required for closing, available annual percentage rate, available monthly savings, available months to recoup closing costs, and available revised payoff time.

16. The method of claim 5 wherein existing mortgage information comprises: name, email address, phone number, property address, city, state, zip code, date to begin receiving mortgage loan reports, frequency of receiving mortgage loan reports, existing mortgage original loan amount, existing mortgage interest rate, existing mortgage loan term, existing mortgage type, existing mortgage closing date, existing mortgage first payment date, existing loan term, and existing mortgage principal paydown amount.

17. The method of claim 1 wherein the desired loan terms comprise: interest rate, mortgage type, mortgage amount, mortgage loan term, and mortgage payment.

18. The method of claim 1 wherein mortgage market data comprise: One Year Treasury Index, twelve month London Interbank Offered Rate (“LIBOR”) Index, six month LIBOR Index, one month LIBOR Index, prime rate, MTA Index, conforming thirty year fixed rate, conforming thirty year fixed interest-only rate, conforming twenty year fixed rate, conforming fifteen year fixed rate, conforming 3/1 adjustable rate mortgage (“ARM”) rate, conforming 3/1 ARM interest only rate, conforming 5/1 ARM rate, conforming 5/1 ARM interest only rate, conforming 7/1 ARM rate, conforming 7/1 ARM interest only rate, conforming 10/1 ARM rate, conforming 10/1 ARM interest-only rate, JUMBO thirty year fixed rate, JUMBO thirty year fixed interest only rate, JUMBO twenty year fixed rate, JUMBO fifteen year fixed rate, JUMBO 3/1 ARM rate, JUMBO 3/1 ARM interest only rate, JUMBO 5/1 ARM rate, JUMBO 5/1 ARM interest only rate, JUMBO 7/1 ARM rate, JUMBO 7/1 ARM interest only rate, JUMBO 10/1 ARM rate, JUMBO 10/1 interest only rate.

19. The method of claim 1 further comprising the step of obtaining mortgage professional marketing information.
